(19) United States
(12) Patent Application Publication
(10) Pub. No.: US 2019/0281113 A1
(43) Pub. Date: Sep. 12, 2019

(54) SYSTEM FOR COMMUNICATING BETWEEN COMPUTING AND STORAGE NODES

(71) Applicant: infinite io, Inc., Austin, TX (US)

(72) Inventors: Jason D. Preston, Austin, TX (US); Chris J. Richards, Plano, TX (US)

(21) Appl. No.: 16/295,479

(22) Filed: Mar. 7, 2019

Related U.S. Application Data
(60) Provisional application No. 62/640,345, filed on Mar. 8, 2018.
(60) Provisional application No. 62/691,176, filed on Jun. 28, 2018.
(60) Provisional application No. 62/691,172, filed on Jun. 28, 2018.
(60) Provisional application No. 62/690,511, filed on Jun. 27, 2018.
(60) Provisional application No. 62/690,502, filed on Jun. 27, 2018.
(60) Provisional application No. 62/690,500, filed on Jun. 27, 2018.
(60) Provisional application No. 62/691,170, filed on Jun. 28, 2018.
(60) Provisional application No. 62/691,167, filed on Jun. 28, 2018.

(51) Int. Cl. H04L 29/08; H04L 12/26; H04L 12/741; G06F 16/23; G06F 16/182

(52) U.S. Cl. CPC H04L 67/1097; H04L 43/028; G06F 16/182; G06F 16/2379; H04L 45/54

(57) ABSTRACT

Systems and methods for migrating metadata are presented. A remote network attached storage server comprises a plurality of network interfaces. Each network interface in the plurality of network interfaces has one or more corresponding internet protocol addresses. A network storage controller comprises: a first computing node comprising a first backplane network interface and a second computing node comprising a network interface logically connected to one of the plurality of network interfaces and a second backplane network interface physically connected to the first backplane network interface. At least one of the first or second computing nodes are configured to perform deep packet inspection on network traffic between a client device and the remote network attached storage server. The at least one of the first or second computing node responds to the network traffic.

### CROSS-REFERENCE TO RELATED APPLICATIONS

This application claims priority to U.S. Provisional Application No. 62/640,345, filed Mar. 8, 2018, U.S. Provisional Application No. 62/691,176, filed Jun. 28, 2018, U.S. Provisional Application No. 62/691,172, filed Jun. 28, 2018, U.S. Provisional Application No. 62/690,511, filed Jun. 27, 2018, U.S. Provisional Application No. 62/690,502, filed Jun. 27, 2018, U.S. Provisional Application No. 62/690,500, filed Jun. 27, 2018, U.S. Provisional Application No. 62/691,170, filed Jun. 28, 2018, and U.S. Provisional Application No. 62/691,167 filed Jun. 28, 2018. The entirety of these provisional applications are herein incorporated by reference.

### TECHNICAL FIELD

The technology described herein relates to metadata processing in a file system.

### BACKGROUND

As data continues to grow at exponential rates, storage systems cannot necessarily scale to the performance required for retrieving, updating, and storing. All too often, the storage systems become a bottleneck to file system performance. End-users may experience poor and unpredictable performance as storage system resources become overwhelmed by requests for data.

Network file systems can suffer from inefficiencies due to the processing of metadata calls. In network file sharing protocols, e.g., network file sharing (NFS), server message block (SMB), etc., a large percentage of remote procedure calls (RPCs) between a client and a network-attached storage (NAS) are related to attributes and access controls of network-accessible objects (NAOs), such as files, on the NAS. These attributes and access controls are referred to as metadata. Metadata calls can comprise 70-90% of the RPCs. Retrieving metadata on the NAS can be relatively slow. For example, a GETATTR call typically takes 500-1000 μs on a NAS with flash-based storage. If slower mechanical drives are used, it may take on the order of milliseconds to reply to a GETATTR call.

Additionally, network file systems can suffer from inefficiencies due to the storage of inactive data. In the typical data center, eighty percent or more of all data is inactive, i.e., the data is accessed briefly and then never accessed again. Inactive data tends to double about every twenty-four months. Storing inactive data on disk may be costly and inefficient. Though cloud or object-based storage can be an ideal platform for storing inactive, or “cold,” data, it typically does not provide the performance required by actively used “hot” data.

FIG. 1 is a diagram depicting a prior art hybrid storage system 100 that includes a client 110, a network storage controller (NSC) 120, a NAS 150, and a cloud-based storage 160. The NSC 120 intercepts traffic between the client 110 and the NAS 150, performs deep packet inspection (DPI) on network file protocols, appropriately forwards traffic or responds to the client 110 or the NAS 150, manages metadata storage, and manages the storage of inactive data. In the hybrid storage system 100, the NSC 120 moves inactive data between the NAS 150 to the cloud-based storage 160 and copies metadata from the NAS 150 to the NSC 120. The NSC 120 comprises one or more engines 122, one or more migration policies 124, a metadata database (MDB) 126, a scan module 128, a review queue 130, a migration queue 132, a cloud seeding module 134, a key safe 138, a file recall module 140, and an apache libcloud library 142.

At startup, the scan module 128 scans the file systems on the NAS 150 to collect all metadata, i.e., attributes, of file system objects (file, directories, etc.) and namespace information about files contained in directories. The metadata is kept in the MDB 126, which is partitioned into slices, each of which contains a portion of the metadata. The mapping of a file's metadata, i.e., an MDB entry, to a slice is determined by some static attribute within the metadata, such as a file handle. The MDB 126 comprises RAM, or any other high-speed storage medium, such that metadata can be retrieved quickly. The metadata is kept in sync using DPI and is learned dynamically in the case where the initial scan has not completed yet. When a metadata request is detected, the NSC 120 generates a reply to the client 110, essentially impersonating the NAS 150.

The one or more migration policies 124 may be instated by a system administrator or other personnel. The one or more migration policies 124 may depend on, e.g., age, size, path, last access, last modified, user ID, group, file size, file extensions, directory, wildcards, or regular expressions. Typically, inactive data is targeted for migration. Files are migrated from the NAS 150 to the cloud-based storage 160 based on whether or not their corresponding metadata matches criteria in the one or more migration policies 124.

In the system 100, the one or more migration policies 124 are applied to the files in the NAS 150. Before a system is fully deployed and in “production” mode, files may enter the review queue 130 after execution of the one or more migration policies 124. Use of the review queue 130 gives system administrators or other personnel a chance to double-check the results of executing the one or more migration policies 124 before finalizing the one or more migration policies 124 and/or the files to be migrated and to the cloud-based storage 160. When the system is in a “production” mode, the files to be migrated may skip the review queue 130 and enter the migration queue 132.

The cloud seeding module 134 is responsible for managing the migration of the files to the cloud-based storage 160. Files migrated to the cloud-based storage 160 appear to the client 110 as if they are on the NAS 150. If the contents of a migrated file are accessed, then the file is automatically restored by the file recall module 140 to the NAS 150 where it is accessed per usual. The apache libcloud 142 serves as an application program interface (API) between the cloud-based storage 160 and the cloud seeding module 134 and the file recall module 140. The key safe 138 includes encryption keys for accessing the memory space in the cloud-based storage 160 used by the system 100.

FIG. 2 depicts an alternate view of a hybrid storage system 200. The hybrid storage system 200 includes the client 110, the NSC 120, the NAS 150, and the cloud-based storage 160. The intercepting device 205 includes a kernel space 210 and a user space 215. The kernel space 210 provides an interface between the user space 215 and the cloud-based storage 160. The kernel space 210 comprises a kernel network interface (KNI) 236, a Linux network stack 238, and sockets 240. The sockets 240 are used by the kernel space 210 to communicate with the scan module 128, the cloud seeding module 134, and the file recall module 140.

A data plane development kit (DPDK) 220 resides in the user space 215. The DPDK 220 is a set of data plane libraries and network interface controller drivers for fast packet processing. The DPDK 220 comprises poll mode drivers 230 that allow the NSC 120 to communicate with the client 110 and the NAS 150.

A typical network proxy can be inserted between a client and a server to accept packets from the client or the server, process the packets, and forward the processed packets to the client or the server. Deploying a typical network proxy can be disruptive because a client may need to be updated to connect to the network proxy instead of the server, any existing connections may need to be terminated, and new connections may need to be started. In a networked storage environment, thousands of clients as well as any applications that were running against the server before the proxy was inserted may need to be updated accordingly.

In contrast from the typical network proxy, the hybrid storage system 200 can dynamically proxy new and existing transmission control protocol (TCP) connections. DPI is used to monitor the connection. If any action is required by the proxy that would alter the stream (i.e., metadata offload, modifying NAS responses to present a unified view of a hybrid storage system, etc.), packets can be inserted or modified on the existing TCP session as needed. Once a TCP session has been spliced and/or stretched, the client's view and the server's view of the TCP sequence are no longer in sync. Thus, the hybrid storage system 200 “warps” the TCP SEQ/ACK numbers in each packet to present a logically consistent view of the TCP stream for both the client and the server. This technique avoids the disruptive deployment process of traditional proxies. It also allows maintenance of the dynamic transparent proxy without having to restart clients.

A metadata database (MDB), e.g., MDB 126 runs under the DPDK 220. In the MDB 126, metadata is divided up into software-defined “slices.” Each slice contains up-to-date metadata about each NAO and related state information. The MDB slices 222 are mapped to disparate hardware elements, i.e., the one or more engines 122. The MDB slices 222 are also mapped, one-to-one, to work queues 224, which can be implemented as memory.

Software running on the DPDK 220 receives requests for information about an NAO, i.e., metadata requests. The software also receives requests for state information related to long-running processes, e.g., queries. When a new metadata request arrives, the software determines which MDB slice 222 houses the metadata that corresponds to the NAO in the request. The ILB 226 places the metadata request into the work queue 244 that corresponds to the MDB slice 222.

An available hardware element, i.e., an engine in the one or more engines 122, reads a request from the work queue 224 and accesses the metadata required to respond to the request in the corresponding MDB slice 222. If information about additional NAOs is required to process the request, additional requests for information from additional MDB slices 222 can be generated, or the request can be forwarded to additional MDB slices 222 and corresponding work queues 224. Encapsulating all information about a slice with the requests that pertain to it make it possible to avoid locking, and to schedule work flexibly across many computing elements, e.g., work queues, thereby improving performance.

Ingest and load balancer (ILB) 226 ensures that the work load is adequately balanced among the one or more work queues 224. The ILB 226 communicates with the poll mode drivers 230 and processes intercepted network packets. The ILB 226 uses a cache 228. The ILB 226 performs a hash of a file handle included in the network file protocol RPC. The hash of the file handle can be passed along by the ILB 226 to one of the work queues based on the result of the hash, which indicates the MDB slice 222 that houses the metadata corresponding to the file handle.

A data plane (DP)/control plane (CP) boundary daemon 234 sits at the edge of the DPDK 220 and communicates with each of the scan module 128, the cloud seeding module 134, the file recall module 140, and the one or more migration policies 124, which reside in a control plane.

When the one or more migration policies 124 are executed, the DP/CP boundary daemon 234 sends a policy query to a scatter gather module 232. The scatter gather module 232 distributes one or more queries to the one or more work queues 224 to determine if any of the metadata in the MDB slices 222 is covered by the one or more migration policies 124. The one or more engines 122 process the one or more queries in the one or more work queues 224 and return the query results to the scatter gather module 232, which forwards the results to the one or more migration policies 124. The cloud seeding module 134 then sends a cloud migration notification to the DP/CP boundary daemon 234, which forwards the notification to the appropriate work queues 224.

Metadata corresponding to NAOs, or files, can reside on the cloud-based storage 160, for disaster recovery purposes. Even though some metadata resides on the cloud-based storage 160 for disaster-recovery purposes, a copy of that metadata can reside in the NSC 120.

File recall module 140 performs reading and writing operations. When a file is to be read from the cloud-based storage 160, the file recall module 140 communicates with the cloud-based storage 160 across the user space 215 through sockets 240 and through the Linux network stack 238 in the kernel space 210. The file to be recalled is brought from the cloud-based storage 160 into the file recall module 140. When a file is to be written to the NAS 150 as part of file recall, the file recall module 150 communicates with the NAS 150 through the sockets 240, the Linux network stack 238, the KNI 236, and the ILB 226. The ILB 226 uses the poll mode drivers 230 to send the recalled file back to the NAS 150.

When the scan for metadata is performed, the scan module 128 communicates with the NAS 150 through the sockets 240, the Linux network stack 238, the KNI 236, and the ILB 226. The ILB 226 uses the poll mode drivers 230 to communicate the scan operations to the NAS 150. The results from the scan operations are sent back to the scan module 128 over the same path in reverse.

FIGS. 1 and 2 are embodied, for example, in NSC-055s, NSC 110, and NSC-110s, sold by Infinite 10, Inc.

### SUMMARY

A system for communicating between computing nodes reliably connected to a remote network attached storage server is presented. A remote network attached storage server comprises a plurality of network interfaces. Each network interface in the plurality of network interfaces having one or more corresponding internet protocol (IP) addresses. A network storage controller comprises: a first computing node comprising a first backplane network interface; and a second computing node comprising a network interface logically connected to one of the plurality of network interfaces and a second backplane network interface physically connected to the first backplane network interface. At least one of the first or second computing nodes are configured to perform deep packet inspection on network traffic between a client device and the remote network attached storage server. A routing database is shared by the first and second computing nodes. The routing database comprises a first mapping of the physical network interface to a first IP address corresponding to a first one of the plurality of network interfaces and a second mapping of the first backplane network interface to a second IP address corresponding to a second one of the plurality of network interfaces.

A method for communicating between computing nodes reliably connected to a remote network attached storage server is presented. A remote network attached storage server comprises a plurality of network interfaces. Each network interface in the plurality of network interfaces has one or more corresponding internet protocol (IP) addresses. A network storage controller comprises a first computing node comprising a first backplane network interface and a second computing node comprising a network interface logically connected to one of the plurality of network interfaces and a second backplane network interface physically connected to the first backplane network interface. At least one of the first or second computing nodes are configured to perform deep packet inspection on network traffic between a client device and the remote network attached storage server. The at least one of the first or second node responds to the metadata requests with metadata from the metadata database. The first and second computing nodes maintain a routing database comprising a first mapping of the physical network interface to a first IP address corresponding to a first one of the plurality of network interfaces and a second mapping of the first backplane network interface to a second IP address corresponding to a second one of the plurality of network interfaces.

A non-transitory computer-readable medium encoded with instructions for commanding one or more data processors to execute steps of a method for communicating between computing nodes reliably connected to a remote network attached storage server is presented. A remote network attached storage server comprises a plurality of network interfaces. Each network interface in the plurality of network interfaces has one or more corresponding internet protocol (IP) addresses. A network storage controller comprises a first computing node comprising a first backplane network interface and a second computing node comprising a network interface logically connected to one of the plurality of network interfaces and a second backplane network interface physically connected to the first backplane network interface. At least one of the first or second computing nodes are configured to perform deep packet inspection on network traffic between a client device and the remote network attached storage server. The at least one of the first or second node responds to the metadata requests with metadata from the metadata database. The first and second computing nodes maintain a routing database comprising a first mapping of the physical network interface to a first IP address corresponding to a first one of the plurality of network interfaces and a second mapping of the first backplane network interface to a second IP address corresponding to a second one of the plurality of network interfaces.

### BRIEF DESCRIPTION OF THE FIGURES

FIG. 1 is a diagram depicting a prior art system that includes a client, a network-based storage controller (NSC), and a NAS.

FIG. 2 is a diagram depicting an alternate view of a prior art hybrid storage system.

FIG. 3 is a diagram depicting a clustered node hybrid storage system that comprises multiple computing nodes.

FIG. 4 is a diagram depicting how the slices in each of the multiple computing nodes communicate with each other.

FIG. 5 is a diagram depicting an alternate view of the clustered node hybrid storage system.

FIG. 6 is a diagram depicting a data plane in a clustered node hybrid storage system

FIG. 7 is a diagram depicting the organization of metadata into MDB slices in an exemplary clustered node hybrid storage system

FIG. 8 is a diagram depicting messaging between computing nodes in a clustered node hybrid storage system.

FIG. 9 is a diagram depicting messaging between computing nodes when a node is added.

FIG. 10 is a diagram depicting messaging between the client, the computing nodes, and the NAS.

FIG. 11 is a diagram depicting messaging between the client, the computing nodes, and the NAS, when a secondary copy of metadata is being transferred to a new node.

FIG. 12 is a diagram depicting messaging between the client, the computing nodes, and the NAS, when a primary copy of metadata is being transferred to a new node.

FIG. 13 is a diagram depicting messaging between the client and the computing nodes in an event of a node failure.

FIG. 14 is a diagram depicting “hot” file metadata access in a clustered node hybrid storage system.

FIG. 15A is a diagram depicting “hot” file access in the clustered node hybrid storage system.

FIG. 15B is a diagram depicting how a file is accessed during a node failure.

FIG. 16 is a diagram depicting a scale out of more nodes in the clustered node hybrid storage system.

FIG. 17 is a diagram depicting the use of multiple switches in a clustered node hybrid storage system to help balance the traffic in the network.

FIG. 18 is a diagram depicting how an update to one or more computing nodes in a clustered hybrid storage system is performed.

FIG. 19 is a diagram depicting an initiator node.

FIG. 20 is a diagram depicting how a work queue for one slice accesses metadata in another slice.

FIG. 21 is a diagram depicting how new metadata is pushed to a slice on a same node or another node.

FIG. 22 is a diagram depicting an auxiliary MDB in a clustered hybrid storage system.

FIG. 23 is a diagram depicting a network topology with connections between computing nodes 1 through N in a cluster and a remote server.

FIG. 24 depicts node interconnections in a system for migrating files from a file server to object-based storage.

FIG. 25 depicts an IP addressing scheme for the NAS.

FIG. 26 depicts a movement of one of the IP addresses on the NAS and a subsequent gratuitous ARP being generated due to the movement.

FIG. 27 depicts a shared database that tracks network interfaces that each NAS cluster IP address is reachable from in a system for migrating files from a file server to object-based storage.

FIG. 28 depicts an updated shared database in a system for migrating files from a file server to object-based storage.

FIG. 29 depicts a shared database in a switched system for migrating files from a file server to object-based storage.

FIG. 30 depicts how an NSC node that is not connected to a NAS node can communicate with that NAS node.

FIG. 31 is a flow diagram depicting a method for communicating between computing nodes reliably connected to a remote network attached storage server.

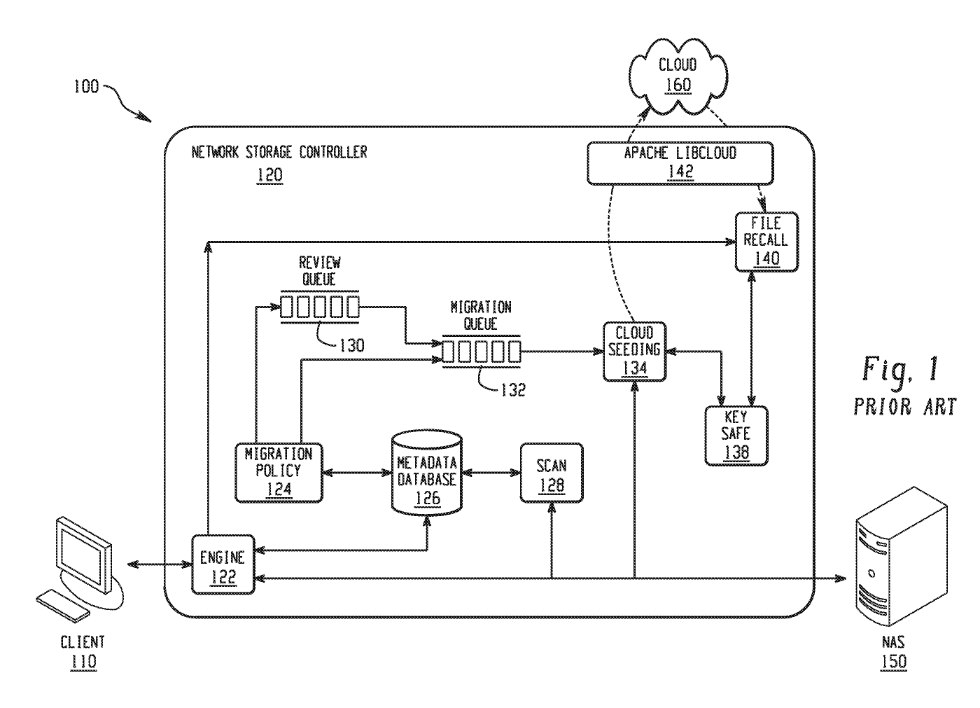

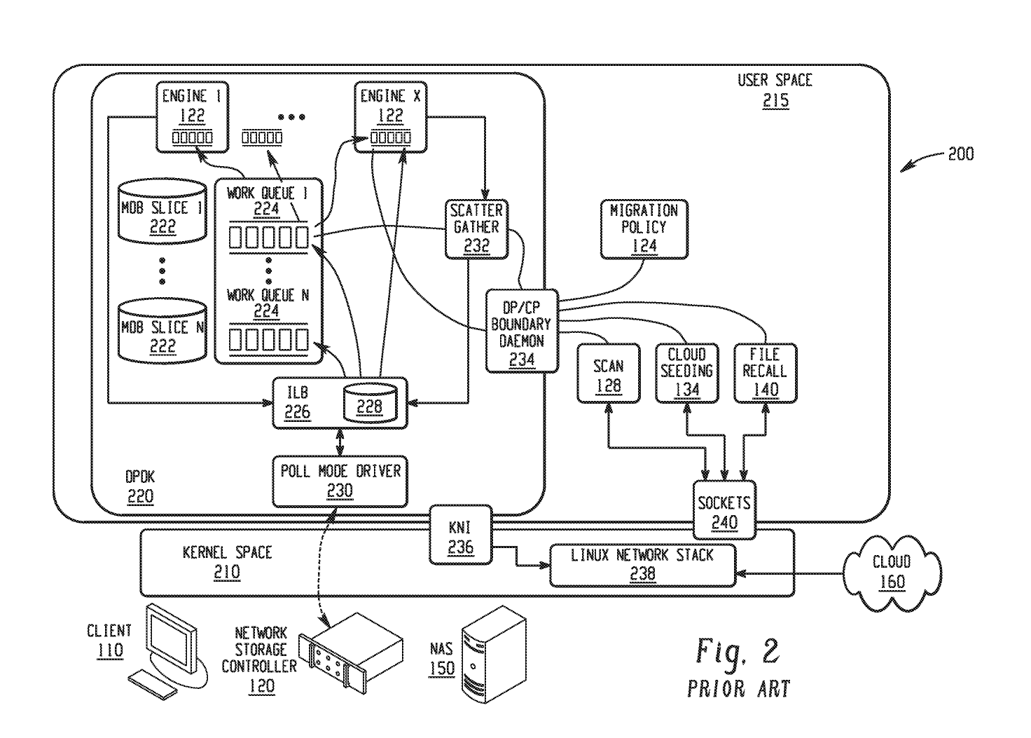

### DETAILED DESCRIPTION

Accelerating metadata requests in a network file system can greatly improve network file system performance. By intercepting the metadata requests between a client and a NAS, offloading the metadata requests from the NAS, and performing deep packet inspection (DPI) on the metadata requests, system performance can be improved in a transparent manner, with no changes to the client, an application running on the client, or the NAS.

System performance can be further improved by providing a hybrid storage system that facilitates the migration of inactive data from the NAS to an object-based storage while maintaining active data within the NAS. The migration of inactive data frees up primary storage in the NAS to service active data.

A clustered node hybrid storage system offers multiple advantages over prior art systems. Service is nearly guaranteed in a clustered node hybrid storage system due to the employment of multiple nodes. For example, a cluster of nodes can withstand controller and storage system failures and support rolling system upgrades while in service. Performance is greatly enhanced in a clustered node hybrid storage system. For example, the time to complete metadata requests is greatly decreased. Reliability of data is also improved. For example, the use of multiple nodes means that multiple copies of data can be stored. In the event that the system configuration changes and/or one of the copies becomes “dirty,” an alternate copy can be retrieved.

Systems and methods for maintaining a database of metadata associated with network-accessible objects (NAOs), such as files on a network attached storage device, are provided herein. The database is designed for high performance, low latency, lock-free access by multiple computing devices across a cluster of such devices. The database also provides fault tolerance in the case of device failures. The metadata can be rapidly searched, modified or queried. The systems and methods described herein may, for example, make it possible to maintain a coherent view of the state of the NAOs that it represents, to respond to network requests with the state, and to report on the state to one or many control plane applications. The database is central to accelerating the metadata requests and facilitating the migration of inactive data from the NAS to the object-based storage.

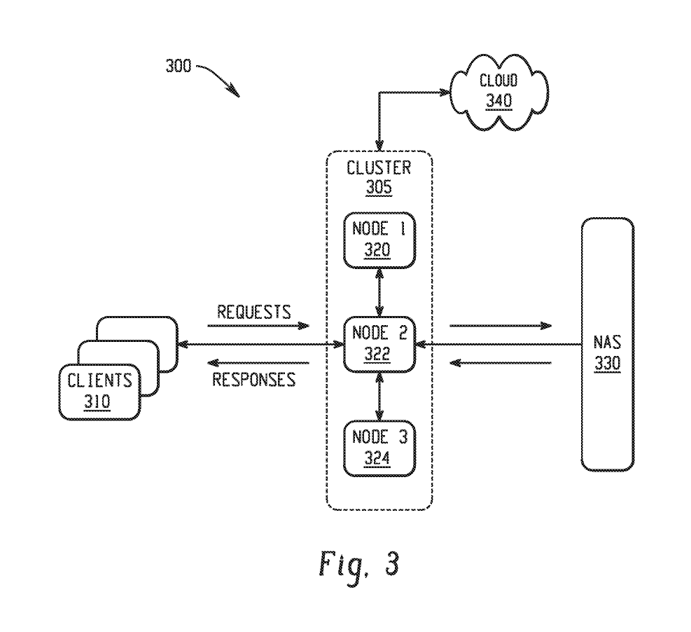

FIG. 3 depicts an clustered node hybrid storage system 300 that comprises a cluster 305 comprising multiple computing nodes, e.g., a first node 320, a second node 322, and a third node 324. The cluster 305 is positioned between one or more clients 310, a NAS 330, and a cloud-based storage 340. The cluster 305 intercepts requests from the one or more clients 310 and responds to the one or more clients 310 appropriately. Likewise, the cluster 305 sends information to and receives information from the NAS 330 in a manner that is transparent to the one or more clients 310. The cluster 305 may move data from the NAS 330 to the cloud 340 depending on policy definitions in one or more migration policies.

In the clustered node hybrid storage system 300, metadata may be housed across multiple computing nodes 320, 322, and 324 in order to maintain state if one or more of the multiple computing nodes 320, 322, or 324, become inaccessible for some period of time. Multiple copies of the metadata across multiple computing nodes 320, 322, and 324, are kept in sync. If a primary node that houses metadata for an NAO is inaccessible, a secondary node may be used to respond to requests until the primary node returns, or until the slice on the primary node can be reconstituted to another node. Thus, loss of access to metadata is mitigated in the event of a failure, and performance is preserved.

Because the mapping of one file's metadata (an MDB entry) to a slice is determined by some static attribute within the metadata, such as a file handle, the node and the slice where the metadata resides in the cluster can be easily computed. On each of the computing nodes 320, 322, and 324, there are a number of work queues, which are data structures that include all of the work requested from a particular MDB slice, as well as the data associated with the MDB slice itself. The work queues have exclusive access to their own MDB slice, and access the MDB entries via query/update application programming interfaces (APIs).

Each computing node comprise one or more engines, such as the one or more engines 122. The one or more engines manage metadata retrieval by representing NFS calls and reply processing as a set of state machines, with states determined by metadata received and transitions driven by an arrival of new metadata. For calls that require just one lookup, the state machine starts in a base state and moves to a terminal state once it has received a response to a query.

Multi-stage retrieval can be more complex. For example, an engine in the one or more engines 122 may follow a sequence. At the beginning of the sequence, the engine 122 starts in a state that indicates it has no metadata. The engine 122 generates a request for a directory's metadata and a file's handle and waits. When the directory's work queue responds with the information, the engine transitions to a next state. In this next state, the engine generates a request for the file's metadata and once again waits. Once the file's work queue responds with the requested information, the engine transitions to a terminal state in the state machine. At this point, all of the information that is needed to respond to a metadata request is available. The engine then grabs a “parked” packet that comprises the requested information from a list of parked packets and responds to the request based on the parked packet.

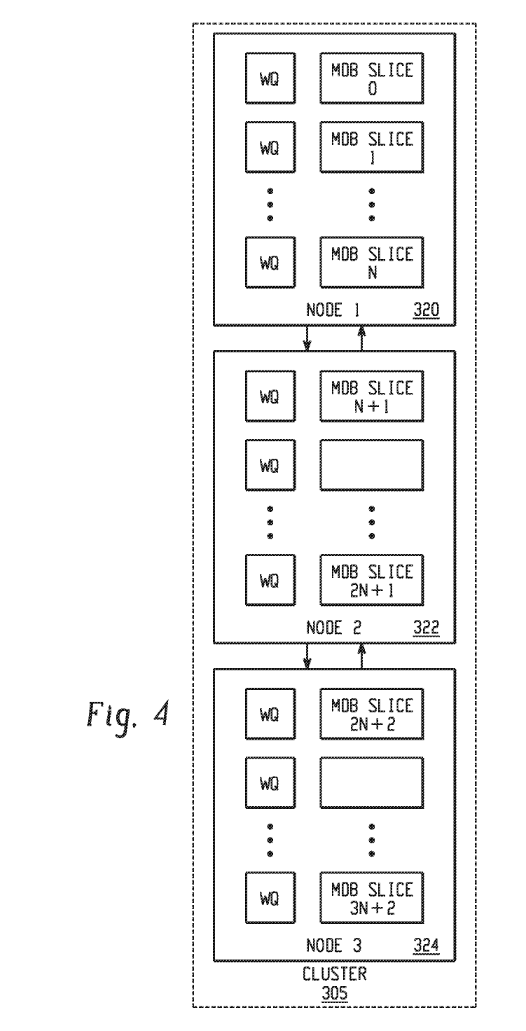

FIG. 4 depicts how the slices in each of the multiple computing nodes 320, 322, and 324 in the clustered node hybrid storage system 300 communicate with each other. In a cluster of N nodes, each slice can be mapped to between 1 and N nodes, depending on the desired redundancy. Thus, information about a file may only exist on one node, or it may exist on multiple nodes, and can be preserved when there are changes to the cluster, such as a change due to a failure or recovery of a node. If a slice is mapped to multiple nodes for redundancy, only one copy of metadata across the cluster will be considered the primary copy. Other copies will be kept up to date in order to respond to cluster changes, but the primary copy is considered authoritative.

In the system 300, MDB slices can be spread across the multiple computing nodes 320, 322, and 324. For example, the first computing node 320 may comprise MDB slices 0 to N, the second computing node 322 may comprise MDB slices N+1 to 2N+1, and the third computing node 324 may comprise MDB slices 2N+2 to 3N+2. If the first computing node 320 receives a request for metadata that is housed on the second computing node 322, the first computing node 320 can pass the request to a work queue corresponding to a first MDB slice that is local to the first computing node 320. The first computing node 320 can communicate with the second node 322 that comprises a second MDB slice that houses the metadata. The second MDB slice can be updated as appropriate based on the request.

When a component, e.g., data processing engine 122, ILB 228, or scatter gather module 232, requests anything in the system that relies on file metadata, the component calculates which MDB slice holds the primary version of the information about the file via mathematical computations based on static attributes of the file, such as a file handle. The component then determines whether the calculated MDB slice resides on the same node in the cluster as the requesting process. If the calculated MDB slice resides on the same node, the component sends the request to the work queue that holds the slice. If the calculated MDB slice is on a different node, the component chooses a local work queue to send the request to, which will then generate an off-node request for the information and act on the response. The work queues also contain other information that is relevant to the work being done on the MDB slice, such as information about migration policy queries.

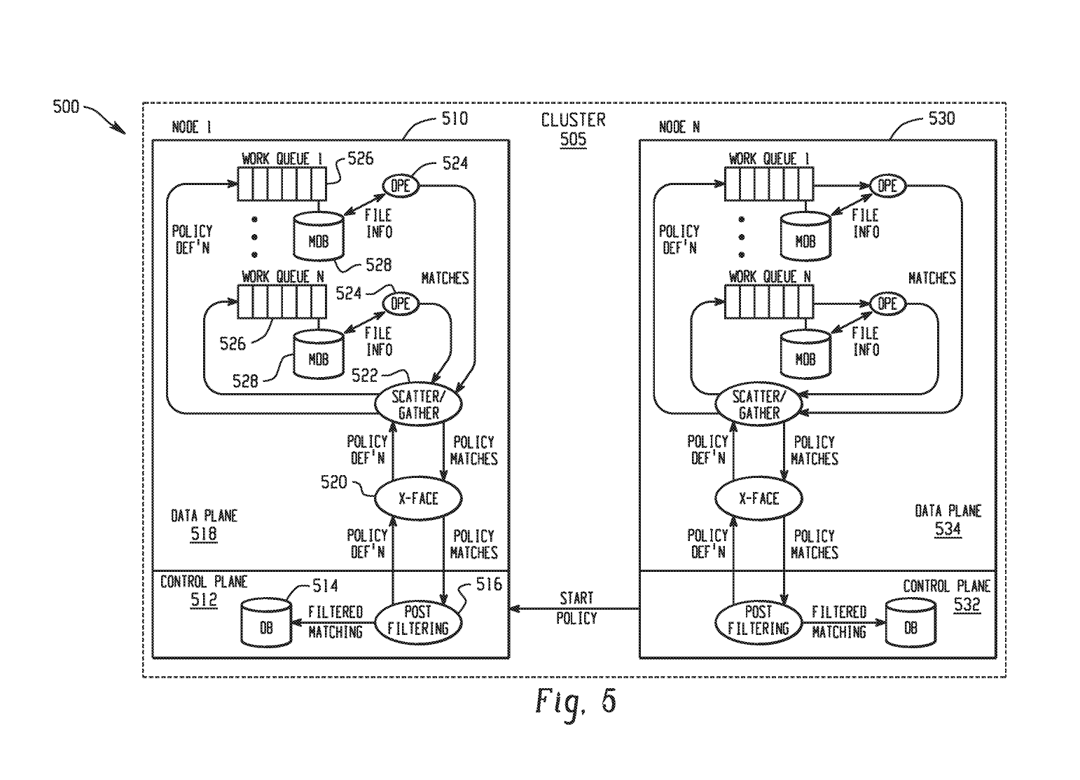

FIG. 5 depicts an alternate view of a clustered node hybrid storage system, e.g., the clustered node hybrid storage system 300. A cluster 505 comprises N computing nodes. A first node 510 comprises a control plane 512 and a data plane 518. An Nth node 530 comprises a control plane 532 and a data plane 534. At some time, the control plane 532 on one or more computing nodes 530 may decide to run a migration policy. This can happen because of periodic scheduling, user interaction, changes to existing policy, changes in the surrounding network infrastructure, and/or other reasons. When the migration policy is executed, the control plane 532 on the one or more computing nodes 530 may notify other nodes in the cluster 505, e.g., a node 510, to start executing the migration policy as well.

Each node, e.g., node 510, reads a policy definition(s) from a shared configuration database 514 and presents it to an interface process 520 in the data plane 518. The interface process 520 receives the policy definition(s), processes and re-formats the policy definition(s), and sends the policy definition(s) to a scatter/gather process 522. The scatter/gather process 522 next performs its scatter step, compiling the policy definition(s) into a form that can be readily ingested by one or more data processing engines (DPEs) 524, and sending the policy definition(s) to all relevant work queues 526. The scatter/gather process 522 can also configure various internal data structures to track the status of the overall policy query so that the scatter/gather process 522 can determine when the work is done.

At some later time, each work queue 526 can be scheduled by the DPE process 524, which receives a message containing the policy definition(s). At that time, the DPE process 524 can do any necessary pre-processing on the policy definition(s) and can attach it to the work queue 526. The data attached to the work queue 526 includes the definition of the file migration policy, information about how much of an MDB slice 528 has been searched so far, and information about the timing of the work performed. Thus, each time the DPE process 524 schedules the work queue 526, the DPE process 524 determines if it is time to do more work (in order to not starve other requests that the work queue 526 has been given). If it time to do more work, the DPE process 524 can determine where in the MDB slice 528 the work should start.

A small portion of the MDB slice 528 can be searched for records that both match the policy definition(s) and that are the primary copy. The DPE process 524 can record a location in the MDB slice where the work left off and can store the location in the work queue 526 so that the next DPE process to schedule the work queue 526 can pick up the work. Because of the structure of the MDB slices 528, work can be done without requiring any locks or other synchronization between the nodes in the cluster 505, or between processing elements, e.g., the DPE processes 524, on a single node. Because the DPE processes 524 search for the primary copy of metadata, metadata will only be matched on a single node, even if copies of the metadata exist on others.

When a DPE process 524 finds one or more files that match the policy definition(s), the DPE process 524 compiles the one or more files into a message and sends the message to the scatter/gather process 522. The scatter/gather process 522 can aggregate messages with matches from other work queues 526, and can also note the progress of the query at each work queue in order to reflect it back to the control plane 512. The scatter/gather process 522 sends the matches to the interface process 520, which passes them back to the control plane 512. Similarly, when a DPE process 524 determines that the policy query has run through all of the data in an MDB slice 528, it tells the scatter/gather process 522. Once the scatter/gather process 522 determines that all of the slices have completed the query, the scatter/gather process 522 communicates to the interface process 520 that the query is complete. The interface process 520 sends the information about query completion to the control plane 512.

The control plane 512 may run post-processing, e.g., filtering, 516 on the query results. This post-processing 516 can include re-constructing a complete path of a file, or doing some additional matching steps that are not readily done on the data plane 518. The control plane 512 stores the filtered results in the database 514. From the database 514, the filtered results can be presented to the user for verification, or moved to the cloud automatically. Because the data plane 518 presents the control plane 512 with a unique set of matching files on each node in the cluster 505, there is no need for locking or other synchronization at this step, other than what is typical for clustered databases with multiple writers.

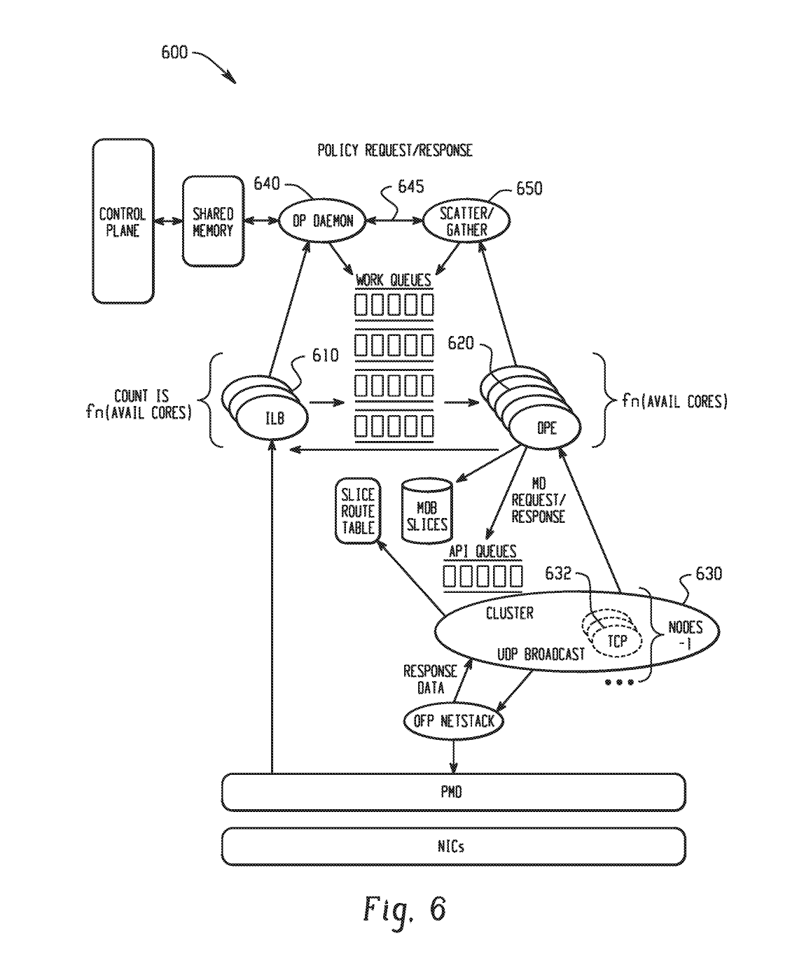

FIG. 6 depicts an alternate view of a data plane 600 in a clustered node hybrid storage system, e.g., the clustered node hybrid storage system 300. A number of ILBs 610 and a number of DPEs 620 are a function of a number of available cores. The ILBs 610 and the DPEs 620 may be shared by multiple computing nodes. The cluster 630 comprises a number of TCP connections 632 that is equal the number of multiple computing nodes minus one. In the data plane 600, policy requests and responses are communicated between a DP daemon 640 and a scatter gather process 650 at 645. Metadata requests and responses are communicated between the DPEs 620 and the cluster 630.

As an alternative to TCP connections 632, user datagram protocol (UDP) could be used for these connections. Though UDP does not guarantee delivery, it is lightweight and efficient. Because the links between two nodes are dedicated, UDP errors would likely be rare and even at that, an acknowledgement/retry could be implemented to provide information about errors.

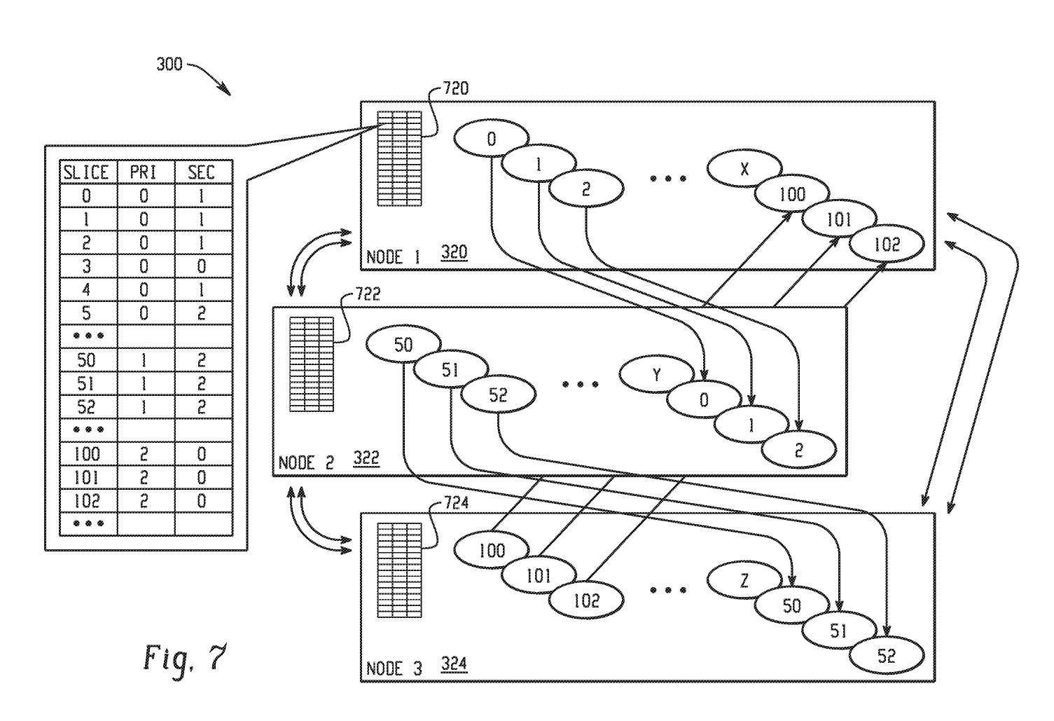

FIG. 7 depicts how metadata can be organized into MDB slices in the exemplary clustered node hybrid storage system 300. Metadata can be distributed across MDB slices within computing nodes 320. Computing node and MDB slice assignment for the metadata related to a file is a function of a file handle for the file. The file handle can be hashed to the slice number, and the slice number can be hashed to the node number that holds a copy of the slice. In other words, slice=hash(file handle) and node=hash(slice).

The hashing algorithm can enable immediate identification of metadata locations in a networked cluster both at steady state and in the presence of one or more cluster node failures and/or cluster node additions. The hashing algorithm can allow all nodes to reach immediate consensus on metadata locations in the cluster without using traditional voting or collaboration among the nodes. Highest random weight (HRW) hashing can be used in combination with hash bins for the hash of the file handle to the slice number, as well as the hash of the slice number to the node number. The HRW hash can produce an ordered list of nodes for each slice and the system can choose the first two.

Redundancy can be achieved by keeping a shadow copy of a slice in the cluster. The slice locations can be logically arbitrary. The initial slice locations can be computed at boot based on a few cluster-wide parameters and stored in an in-memory table. All nodes hold a copy of the slice assignments and fill out a routing table, or a slice route table, in parallel using the same node assignment rules.

To maintain consistent hashing, a size of the slice route table can remain fixed in an event of a node failure or a node addition in a cluster. To achieve a fixed size, a number of slices are allocated and then slices are moved around on in an event of node failure or addition. The system can compute an optimal resource pre-allocation that will support the number of file handles that might map to each slice based on the following parameters: 1) a total number of desired slices in the cluster; 2) maximum number of nodes; and 3) a total number of file handles. Additional scale-out, i.e., addition of nodes, may require changes to the parameter values provided to the system.

In the exemplary system 300, each computing node comprises a slice route table. The first node 320 comprises a slice route table 720, the second node 322 comprises a slice route table 722, and the third node 324 comprises a slice route table 724. The slice route table 720 is exploded to provide a more detailed view. Each of the slice route tables 720, 722, and 724 comprises three columns that include a slice number, a node number of the primary copy of the metadata, and a node number of the secondary copy of the metadata. The slice route table 720 indicates that the primary copy of metadata in slices 0, 1, and 2 is in node 0, and the secondary copy of the metadata in slices 0, 1, and 2 is in node 1. The slice route table 720 also indicates that the primary copy of metadata in slices 50, 51, and 52 is in node 1, and the secondary copy of metadata in in slices 100, 101, and 102 is in node 2. The slice route table 720 further indicates that the primary copy of metadata in slices 100, 101, and 102 is in node 2, and the secondary copy of metadata in in slices 100, 101, and 102 is in node 0.

Each of the nodes 320, 322, and 324 can maintain primary copies of metadata separately from secondary copies of metadata. Thus, in the first node 320, the primary copies of the metadata in slices 0, 1, and 2 can be separated from the secondary copies of the metadata in slices 100, 101, and 102. Arrows are drawn from the primary copies of the metadata to the secondary copies of the metadata.

Because a node can be arbitrarily assigned to hold an MDB slice, it is possible to redistribute the slices when needed and to optimize the assignments based on load. Additionally, the system 300 can enjoy a measure of load balancing simply due to 1) randomness in assignment of file handles to nodes; and 2) uniform distribution ensured by HRW hashing.

Cluster nodes can be assigned persistent identifiers (IDs) when added to the cluster. A list of available nodes and their corresponding IDs can be maintained in the cluster in shared configuration. An arbitrary number of hash bins, NUMBER_HASH_BINS, can be configured for the cluster. All nodes can agree on the value of NUMBER_HASH_BINS and the value can be held constant in the cluster regardless of cluster size.

A collection of in-memory hash bins can be established based on NUMBER_HASH_BINS. Each hash bin conveys the following information:

```
hash_bin:
      id
      primary_node_id
      secondary_node_id
```

A secondary list, online_nodes, can be computed as the subset of nodes that are known by the current node to be in good standing. When a node fails, that failed node's ID can be removed from the online_nodes list. An HRW hash can be computed for the resulting online_nodes by computing a salted HRW hash for each combination of node ID and hash bin ID. The node with the highest random weight can be recorded as primary_node_id for the hash bin. To accommodate redundancy, the node with the second highest random weight can be recorded as the secondary_node_id location for the hash bin. This way, the properties of the HRW hash can be leveraged to provide a stable location for the cluster hash bins based only on the number of nodes available and their corresponding IDs.

To determine the location of a file handle's associated metadata in the cluster, the file handle can be hashed on-the-fly to a hash bin as follows.

```
hash_bin_id = crc_hash(file_handle_string) modulo
NUMBER_HASH_BINS
      where crc_hash is 32 bit cyclic redundancy hash
      where file_handle_string is a 64 byte NFS file handle
      where NUMBER_HASH_BINS is a cluster wide constant
```

Because the hash_bin locations are stable, the aforementioned algorithm can provide a stable hash whereby every node in the cluster can independently compute and know the primary and secondary location of the metadata for any arbitrary NFS file handle.

An approach to managing hash bin changes due to node failure can be utilized in which the hash bin changes are managed independently in a cluster by each node. When a node discovers a topology change resulting from a node failure, a new online_nodes list can be computed and a new set of HRW hashes corresponding to the new list. The primary_node_id and secondary_node_id can be immediately updated in the node hash bins to avoid unnecessary attempts to contact a failed node. Due to the HRW hash characteristics, the net effects are 1) the secondary location can be immediately promoted to be the primary location without loss of service; and 2) the majority of the routes do not change and thus the cluster remains balanced, having only suffered a loss in metadata redundancy due to the node failure. The cluster can work in parallel to restore the lost metadata redundancy.

Because there can be a race condition between a node failure and other nodes knowing about that failure and updating their hash bins, the message routing mechanism on each node can tolerate attempts to send messages to a failed node by implementing a retry mechanism. Each retry can consult the appropriate hash_bin to determine the current route which may have been updated since the prior attempt. Thus, cutover can happen as soon as a node discovers a failure. In combination, the retry window is minimized because failure detection can be expedited through the use of persistent TCP node connections that trigger hash_bin updates when a connection loss is detected. In addition, all nodes can periodically monitor the status of all other nodes through a backplane as a secondary means of ensuring node failures are detected in a timely manner.

Node additions can present similar race conditions because they can require the metadata to be re-balanced through the cluster, with the nodes agreeing on the new locations. Whereas coordination or locking could be utilized to make sure all nodes agree on the new values for all routes, this could cause contention and delay and result in some file accesses being postponed during the coordination interval. The HRW hash discussed previously can ensure that disruptions are minimized because of its well-known properties. Also, any necessary file route changes do not impact subsequent NFS file accesses. In this case, when new nodes are discovered, a new online_nodes list can be computed, and corresponding new HRW hashes computed from the new list and hash bin IDs. New routes can be recorded and held in the hash bins as follows:

```
hash_bin
    id
    primary_node_id
    secondary_node_id
    pending_primary_node_id
    pending_secondary_node_id
```

From the point when a new node is discovered and new routes recorded in the hash bins as pending_primary_node_id and pending_secondary_node_id, the metadata from both old and new routes can be updated with any subsequent changes due to NFS accesses, however, internal metadata can be read from the old cluster routes (primary_node_id, secondary_node_id). In the meantime, the nodes in the cluster can work in parallel to update the metadata at the new routes from the metadata at the old routes. Once all such updates are done, the new routes can be cutover by copying pending_primary_node_id into primary_node_id and pending_secondary_node_id into secondary_node_id. An additional interval can be provided during the cutover so that ongoing accesses that are directed at the old routes can complete. After that interval has expired, the old metadata can be purged.

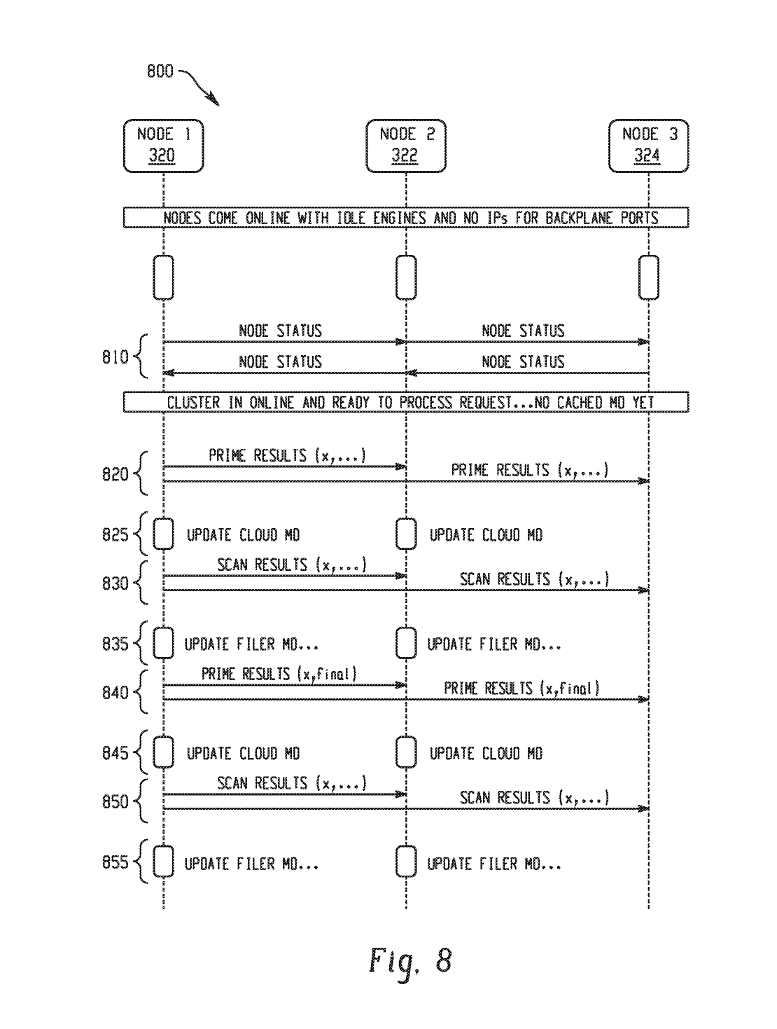

FIG. 8 is a diagram 800 depicting messaging between computing nodes in a clustered node hybrid storage system. Messaging between computing nodes, i.e., “internode messaging” can occur over a set of dedicated ports on each node, chained together into a duplex ring, the shape of which can be discoverable by the nodes. An internode module can abstract these details and provides an API to send a message to a particular node or to all nodes. The internode module chooses the best path, i.e., logically forward or reverse and also bypassing failed links along the way) based on its awareness of a state of the duplex ring. The internode module records source nodeId and destination nodeId for each message and uses that to infer status of the duplex ring as it processes inbound messages. In this way, the internode component maintains a status snapshot of the duplex ring.

All messages have a common routing envelope including: source node ID; destination node ID, which can be set to “all”; and message type. The message type may include any one of a number of message types. Descriptions follow each of the message types:
NODE_STATUS(nodeStatus, nodePathUids)
Each node can periodically broadcast one of nodeStatus or nodePathUids to 1) apprise the nodes of the shape and status of the ring/connectivity; 2) apprise the nodes of healthy nodes. The NODE_STATUS message can be broadcast in each direction on the ring. When a first node sees nodeStatus of a second node, the first node knows the state of the second node. When a first node receives its own nodeStatus, it can interrogate the nodePathUids to know the state of the ring, i.e., information necessary to make the best utilization of the ring resources.
FILE_METADATA_REQUEST(fileHandle)
A node can request file metadata from another node. Note: The exemplary system can assume that the metadata size is such that there is no advantage in distinguishing between types of metadata, i.e., content location vs. file attributes, and instead it can retrieves all metadata related to an NAO, or file, in a single query/response pair.
FILE_METADATA_RESP(fileMetadata)
A node can respond to a request for file metadata.
NEW_SLICE(nodad, sliceId)
A node can indicate the sliceId of a new slice that is present on the specified node.
SLICE_CHECK(sliceId, knownCopies [−1, 0, 1 . . . ])
This message can be used as a health check mechanism to query the status of all slices. The parameter knownCopies allows the sending node to convey what it already knows about a slice. A value of −1 can indicate that the sending node has no information about copies of the slice. A value of 0 can indicate that the sending node does not have a copy. A value of 1 can indicate that the sending node does have a copy. A sending node checking for a copy of a slice that the node holds could send a value of 1. If this message is used as a health check mechanism to query the status of all slices, the sending node may not want to convey any new information to the receiving node.
SLICE_CHECK RESP(slicePresent, otherSliceHealthStats)
A node can respond to a request to check for a slice. The parameter slicePresent can mean that the sending node has a copy.
SLICE_SYNC_REQUEST(sliceId)
The parameter sliceId can correspond to a slice that the sending node wishes to synchronize. The receiving node can respond synchronously with SLICE_SYNC_RESP and then asynchronously with one or more TRANSFER_CHUNK messages and zero or more SLICE_SYNC_UPDATE messages.
SLICE_SYNC_RESP(numberOfChunks)
A node that receives SLICE_SYNC_REQUEST indicates how many raw chunks the node that sent SLICE_SYNC_REQUEST should expect. Chunks can be sent asynchronously with one or more TRANSFER_CHUNK messages and zero or more SLICE_SYNC_UPDATE messages.
SLICE SYNC CHUNK(sliceId, chunkid, chunk)
A node can send a raw slice chunk.
SLICE_SYNC_UPDATE(sliceId, update)
A node can express a logical update to a slice. Whereas TRANSFER_CHUNK can be a part of a stream of chunks, SLICE_UPDATE can be logically complete.
TRANSFER_CHUNK(handle, sequence, chunkLen, chunkData)
This message can be used to transfer an arbitrarily sized data structure between nodes.
SLICE_ROUTE_REQUEST( )
A node can request a slice route table from another node.
SLICE_ROUTE_RESPONSE(sliceNodes)
A node can respond to a request for a slice route table with a list of slice and node assignments.

Discovery of failed nodes can be an important feature of the clustered hybrid storage system. When a node failure occurs, the cluster will not necessarily know which node the session will be redirected to, since the front-end network makes decisions about redirection. Given that a node can see in-flight traffic for a session in which the node has had no active role, the node can assume the session has been redirected to it because of some node failure. This is similar to the case where a new node is brought up and sees traffic, but different in that the node must assume this traffic was previously being handled by some other, now failed node. Thus, traffic is treated differently as between when a new node is added and when an established node sees in-flight traffic.

Some failure scenarios are not amenable to immediate discovery, such as in cases where the failing node is struggling but interfaces of the struggling node are still up. The front-end network may take some time to cutover or may not cutover at all depending on the nature of the failure. In these cases, the failing node can detect its own health issue(s) and pull down interfaces in a timely manner so that the network can adjust. A watchdog can be used to pull down the interfaces down. A node can stop tickling the watchdog in any critical soft-failure it detects and the watchdog will take the interfaces down so that the front-end network will reroute to another node.

As the size of the cluster grows, internode links can be become a scaling bottleneck at some point because 1) the probability that a given request will need to go off-node to get metadata increases with cluster size; and 2) the efficiency of internode messaging decreases with cluster size because the internode links form a ring, not a bus.

A health module can monitor the sanity of a node, triggering appropriate state transitions for the node and conveying the information to a user interface (UI). A parameter can be provided to control node sanity check interval. The health module on each node will periodically transmit a node sanity message and an internode component will ensure that all nodes that are able receive the node sanity message. Likewise the health module can register for such messages and accumulate them into a cluster model. The cluster model can be presented to the UI and can also be available to optimize file metadata lookups (nodes known to be down need not be consulted). Node sanity information can include:
Node State—a red/yellow/green rollup indicating node's ability to take on new requests
Internode link status (red/yellow/green for each logical link pair and each physical link)
Front end Data link status (red/yellow/green for each link)
Back end Data link status (red/yellow/green for each link)
Saturation—a rough indication of node utilization/ability to take on new requests
CPU utilization
Engine status red/yellow/green

The health module can continuously interrogate/scan node slices to ensure they are healthy, i.e., are adequately protected in the cluster. This is distinct from real-time fail-over; this is a background process that can provide a safety net when things go wrong. The health module can perform a redundancy check—scan all slices on the current node and ensure that there is one additional copy in the cluster. The health module can send a SLICE_CHECK message, and on receipt of a positive reply the slice being checked can be timestamped. A parameter can be provided to determine the frequency of slice health checks. To optimize the process, a SLICE_CHECK can optionally convey an identifier of the sender's corresponding slice, allowing the receiver to timestamp his slice as healthy. This identifier can be optional so that SLICE_CHECK can be used by nodes that do not yet have an up-to-date copy of a slice, e.g., a node entering the cluster for the first time. If the target slice is not present on the target node and should be (something that the node itself can verify), the target node can immediately initiate a SLICE_WATCH to retrieve a copy of the slice. The SLICE_CHECK response can also convey interesting slice information such as number of file handles, percentage full, and/or other diagnostics.

Byzantine failures are ones where nodes do not agree because they have inaccurate or incomplete information. A “split brain” scenario refers to a cluster that is partitioned in such a way that the pieces continue to operate as if they each are the entire cluster. Split brain scenarios are problematic because they generate potentially damaging chatter and/or over-replication. A particularly problematic failure scenario could be a two node failure where both node failures also take down the internode links that they hold.

Potential failure scenarios can be bounded by the system architecture. For example, a ring topology can bound the problem space because the number of nodes can change in a fairly controlled fashion. The system can know when a status of the ring, what the node count is, and thus, when the ring degrades. Because metadata is redistributed on the first failure, a second failure will not result in a loss of metadata. This opens the door for a very practical way to limit the byzantine failures. Once the ring is successfully up, when nodes see more than one node go missing they can suppress metadata redistribution until either 1) cluster is restored to <=1 node failure; or 2) the ring is restored, e.g. route around the failed node(s). This way the cluster can remain functional in a two node failure scenario, avoiding all subsequent failures that might result from attempting to redistribute metadata after a second node failure. It can also provide a practical way to restore replication in the corner cases that deal with two node failures in a very large cluster.

As previously mentioned, a primary and secondary copy of metadata “slices” can be maintained in the cluster in arbitrary locations as determined by the node hash. Node and slice IDs can be recorded in a slice route table maintained on each node. The slice route table can be computed based on the number of slices and the nodes in the cluster. Node failures and node additions can cause the slice route table to be dynamically updated. The general approach is that all nodes, given the same inputs, can compute the same slice route table and similarly all nodes can then work in parallel to achieve that desired distribution.

Redistribution of metadata can involve determining what the new distribution should be. Performing the determination in a distributed fashion has advantages over electing a single node to coordinate the decision. For example, coordinated agreement in a distributed system can be problematic due to race conditions, lost messages, etc. All the nodes can execute a same route computation algorithm in parallel to converge at the new distribution.

One or more nodes can detect a failure or a new node and the one or more nodes can send one or more NODE_STATUS_CHANGE messages to the cluster to expedite cluster awareness. Sending a NODE_STATUS_CHANGE message can have the immediate effect that nodes will stop attempting to retrieve metadata from that node and revert to secondary copies of that metadata. Each node can then compute new routes for the failed node and look for new assignments to itself. A SLICE_SYNC message can be initiated for the new routes.

SLICE_SYNC Protocol (Node RX retrieving from Node TX):
1. A node TX can receive a SLICE_SYNC_REQUEST request.
2. The node TX can register a node RX as a listener for updates to the slice.
3. Network requests that need metadata from the slice or that update the metadata can be routed to the node TX, and any metadata changes can initiate a SLICE_UPDATE message to the registered listener (Node RX).
4. When the node RX has successfully received the slice, the node RX can send a cluster-wide NEW_SLICE notice.
5. Receipt of a NEW_SLICE notice can cause any node to mark the new location in its slice route table. Nodes that are holding the slice can let any active operations complete, then delete the slice. The node TX can send a SLICE_UPDATE to the node RX for any operations that complete after the slice transfer is complete.

In a redistribution, a re-scan can be initiated. Any secondary slices that have become primary may not know the last access date of the files, and thus those files may not be seeded. If the date was defaulted to the last known date, it could lead to premature seeding.

The slice route table may be in contention as nodes come and go. A form of stable hashing, i.e., the HRW hash algorithm, can be used to partially manage this contention so that the hash from any given slice ID will produce the same ordered list of candidate nodes when computed from any node in the system. The top two results, i.e., primary and secondary, can be captured in the slice route table. The number of slices can be fixed so that the HRW hashes are computed at boot and when the node list changes. Slices can be over-allocated to provide further hash stability. The size of the hash table can remain fixed as nodes are added and/or removed by rerouting slices to other nodes.

In general, when a node is booted, it allows itself some settle time to detect the node topology and then computes its slice route table using the HRW hashes, ignoring itself as a candidate for any route. The node can go to other nodes for metadata so that it can enable its interfaces and begin processing packets. The node can also determine which slices should be moved to itself and initiate SLICE_SYNC messages on those slices. As the slices come online, the associated NEW_SLICE messages can cause all nodes in the cluster to update their slice route tables.

With clustering, there may be no correlation between a node hosting/capturing a request and a node that holds the metadata slice corresponding to the file handle determined from the request. This can be addressed with various options. As one example, captured packets can be routed through the node holding the metadata slice. Second, the metadata can be retrieved from the primary or secondary slice and used. If there are metadata updates, the metadata updates can be forwarded back to the node(s) corresponding to the slice. Metadata can be retrieved to the node capturing the request, and if needed, updates can be sent back to where the slice copies live.

Near-simultaneous updates from separate nodes can cause race conditions leaving the cached metadata inconsistent with the NAS depending on which update wins. Such inconsistencies could eventually be rectified, but they could persist until the next time that file is accessed on the NAS. Such race conditions are already common with NFS, such that the NFS protocol does not guarantee cache consistency.

The capturing node can consult the corresponding slice route table to determine which nodes are holding the metadata. The metadata can be retrieved from the primary node if the primary node is online. If the primary node is not online, the metadata can be retrieved from the secondary node. In either case, the metadata can be used to determine if the file is cloud-seeded or not. Handling for cloud-seeded files can use the metadata from either primary copy or the secondary copy. Handling for hot files can use the primary copy of metadata and revert to the NAS if needed. If it turns out that the NFS operation also updates the file metadata, the updates can be pushed to the primary and secondary slices following similar rules: cloud-seeded files can have their primary and secondary slices updated, whereas hot files can have their primary slice updated.

To achieve fast slice lookup, slice to node assignments can be precomputed (an HRW hash) and stored in the sliceNode array. The code snippet below demonstrates logic to lookup the primary and secondary node assignments for a file handle.

// assume numberSlices is a file level variable that has been initialized
// from a knob...
void getSliceNodes(uint32_t handleHash, int* primaryPtr,
int* secondaryPtr) {
// get primary and secondary nodes for given file handle...
int sliceIndex = handleHash % numberSlices;
*primaryPtr = sliceNodes[sliceIndex][0];
*secondaryPtr = sliceNodes[sliceIndex][1];
}

An engine can hold slices in memory, pulling metadata from them as needed. Instead of pulling from its local MDB slices, the metadata might need to be retrieved via internode FILE_METADATA_REQUEST requests and logically linked to the packets being processed. Inbound packets may contain multiple operations such that the metadata requests could be performed in parallel. Upon completion of a request, any metadata changes can be sent back to the primary node holding the metadata via internode SLICE_UPDATE notices.

Cloud-seeded files have an additional level of complexity. If attributes change only on the primary slice, they could be lost in the event of a node failure. To remedy this, file attribute changes for cloud-seeded files can be synched to the secondary slice.

In FIG. 8, the first node 320, the second node 322, and the third node 324 come online with idle engines and no internet protocol (IP) addresses for backplane ports. Each of the nodes 320, 322, and 324 can be provisioned by its control plane. Each control plane can allocate slices, fill out a slice route table, and initialize the engines. The control plane in the first node 320 can schedule scanning and priming operations. At 810, each of the nodes 320, 322, and 324 can broadcast a NODE_STATUS message to indicate its health. At this point, the cluster is online and ready to process requests and no metadata has been cached yet.

Priming is the process of initializing the data plane with known file metadata assigned to nodes. The control plane can query a cloud database for metadata and send resulting data to the data plane. The data plane can hash incoming file handles, partition the metadata into MDB slices, and discard metadata not assigned to the node. Scanning, also performed by the control plane, is the process of recursively searching the file structure on each mount, gathering metadata, and pipelining metadata to the data plane in batches, e.g., files, while it is being gathered. The control plane can distribute the scanning process using a distributed algorithm wherein the mounts are broken into logical sections then assigned in order to the known nodes by a node-unique ID (UID). Each node can scan each logical section, e.g., each unique mount point, assigned to itself. The data plane can collate the metadata and distribute it to the nodes according to the slice route table (e.g. primary and secondary slices) using the internode messaging services.

At 820, the control plane from the first node 320 can query the cloud database for known metadata and send resulting data to the data plane from the first node 320. The data plane from the first node 320 can hash all incoming file handles and send metadata not assigned to the first node 320 to the second and third nodes, 322 and 324. The control plane in the first and second nodes, 320 and 322, can update the metadata in the MDB at 825. At 830, the control plane from the first node 320 can distribute the scanning process across the nodes according to the UID or send results of running the scanning process to the nodes. Each of the nodes 320, 322, and 324 can scan each logical section, e.g., each unique mount point, in the NFS assigned to itself. The control plane in the first and second nodes 320 and 322 can update the MDB with metadata from the filer, i.e., the NFS, at 835. At 840, the scanning process completes, and final results are sent. At 845, 850, and 855, the previous four updating, scanning, and updating steps are repeated.

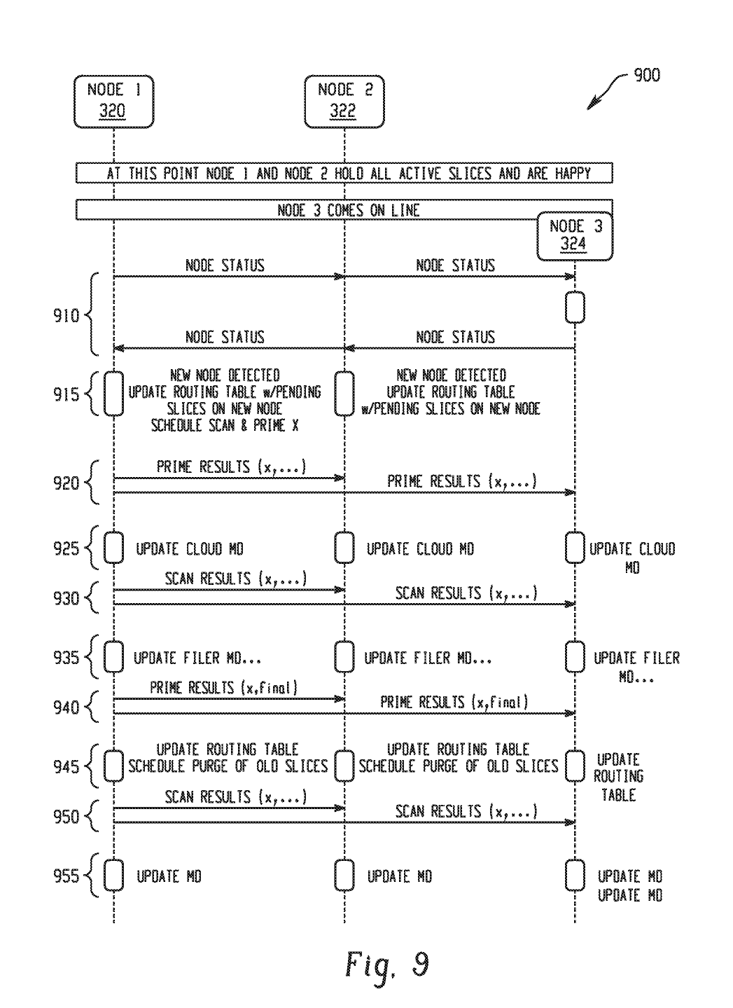

FIG. 9 is a diagram 900 depicting messaging between computing nodes when a node is added. The first node 320 and second node 322 are online and hold all active slices before the third node 324 is added. Once the third node 324 comes online, at 910, each of the nodes 320, 322, and 324 can broadcast a NODE_STATUS message to indicate its health. At 915, the first and second nodes 320 and 322 can detect the third node 324 and update their slice route table with pending slices on the third node 324. The first node 320 can schedule scanning and priming operations. At 920, the control plane from the first node 320 can query the cloud database for known metadata and send resulting data to the data plane from the first node 320. The data plane from the first node 320 can hash all incoming file handles and send metadata not assigned to the first node 320 to the second and third nodes, 322 and 324. The control plane in the first and second nodes, 320 and 322, can update the MDB with metadata from the cloud database at 925.

At 930, the control plane from the first node 320 can distribute the scanning process across the nodes according to the UID or send results of running the scanning process to the nodes. Each of the nodes 320, 322, and 324 can scan each logical section, e.g., each unique mount point, in the NFS assigned to itself. The control plane in the first and second nodes 320 and 322 can update the metadata in the filer, i.e., the NFS, at 935. At 940, the scanning process completes, and final results are sent. At 945, each of the nodes 320, 322, and 324 update their own slice route tables. The first and second nodes, 320 and 322, schedule a purge of old slices. At 950, the control plane from the first node 320 can distribute the scanning process across the nodes according to the UID or send results of running the scanning process to the nodes. Each of the nodes 320, 322, and 324 can scan each logical section, e.g., each unique mount point, in the NFS assigned to itself. The control plane in the first and second nodes 320 and 322 can update the MDB with metadata from the filer, i.e., the NFS at 955.

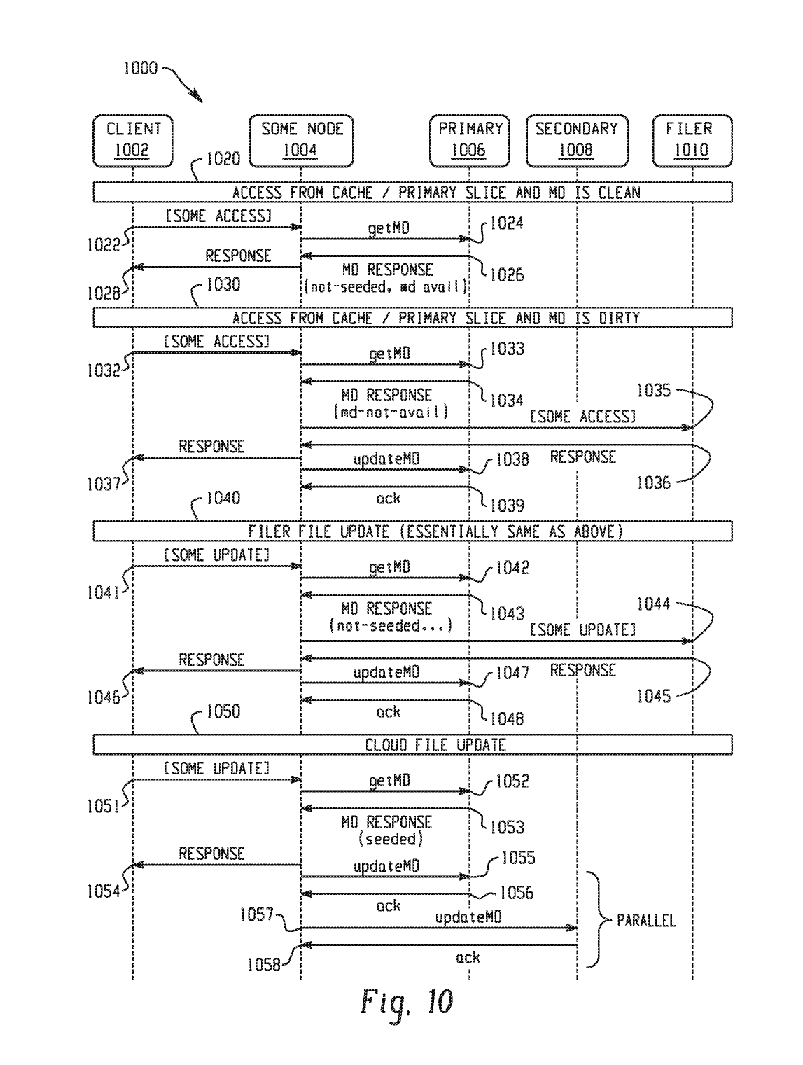

FIG. 10 is a diagram 1000 depicting exemplary messaging between a client 1002, computing nodes 1004, 1006, and 1008, and a filer 1010. At 1020, metadata in a primary node 1006 is clean. At 1022, the client 1002 can perform an operation that that requires access to metadata. The operation can be communicated to some node 1004. At 1024, the some node 1004 can communicate with the primary node 1006 to access the metadata. The primary node 1006 can respond with the metadata at 1026 and indicate that the file is not seeded for the cloud and that the metadata is available. The some node 1004 can respond to the client 1002 at 1028.

At 1030, the metadata in the primary node 1006 is dirty. At 1032, the client 1002 performs an operation that that requires access to metadata. The operation can be communicated to the some node 1004. At 1033, the some node 1004 can communicate with the primary node 1006 to access the metadata. The primary node 1006 can respond to a request for the metadata at 1034, indicating that the metadata is not available. At 1035, the some node 1004 can communicate with the NAS 1010. At 1036, the NAS 1010 can respond with the metadata. At 1037, the some node 1004 can respond to the client 1002 with the metadata. At 1038, the some node 1004 can update the metadata on the primary node 1006. The primary node 1006 can acknowledge the update at 1039.

At 1040, operations that result in an update to a file on the NAS 1010 can occur. The operations are substantially similar to the previous case where the metadata in the primary node 1006 was dirty. At 1041, the client 1002 can perform an update operation on a file. The update operation can be communicated to the some node 1004. At 1042, the some node 1004 can communicate with the primary node 1006 to access the metadata for the file. The primary node 1006 can respond to a request for the metadata at 1043, indicating that the file is not seeded. At 1044, the some node 1004 can communicate with the NAS 1010 to perform the update operation on the file. At 1045, the NAS 1010 can respond to the some node 1004, and at 1046, the some node 1004 can respond to the client 1002 with the metadata. At 1047, the some node 1004 can update the metadata on the primary node 1006. The primary node 1006 can acknowledge the update at 1048.

At 1050, operations occur that result in an update to a file in a cloud-based storage. At 1051, the client 1002 can perform an update operation on a file. The update operation can be communicated to the some node 1004. At 1052, the some node 1004 can communicate with the primary node 1006 to access the metadata for the file. The primary node 1006 can respond to a request for the metadata at 1053, indicating that the file is seeded (on or destined for the cloud-based storage). At 1054, the some node 1004 can respond to the client 1002. At 1055, the some node 1004 can communicate with the primary node 1006 to update the metadata. At 1056, the primary node 1006 can respond to the some node 1004 with an acknowledgment. At 1057, the some node 1004 can update the metadata on the secondary node 1008. The secondary node 1008 can acknowledge the update at 1058.

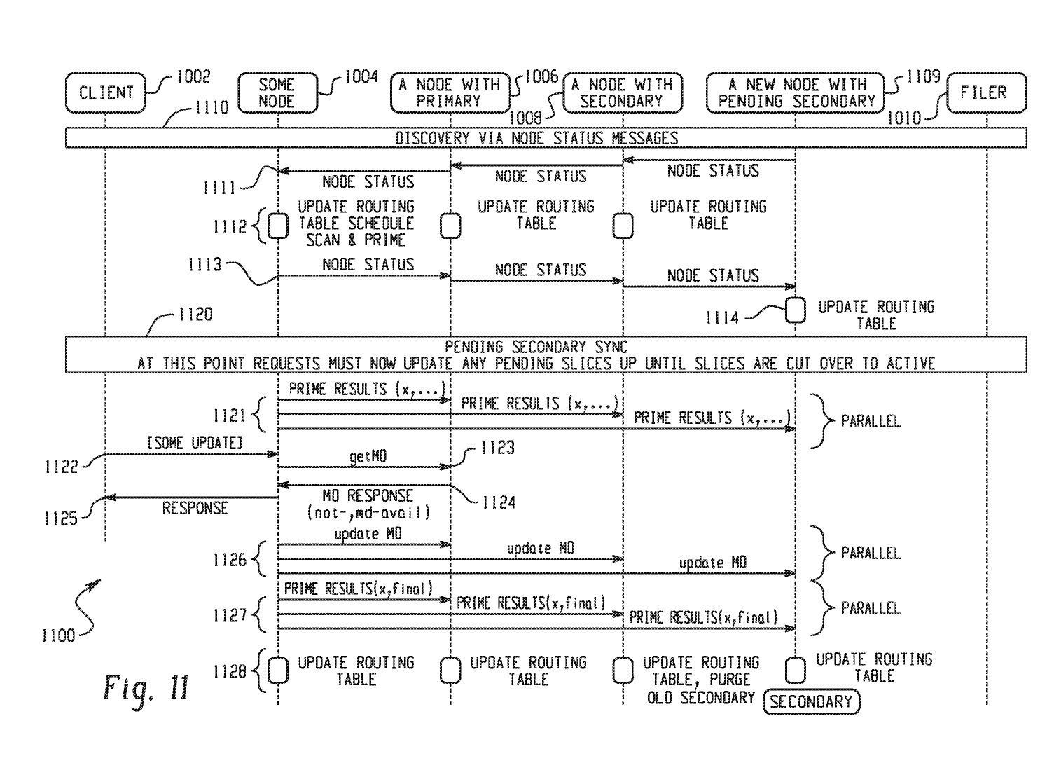

FIG. 11 is a diagram 1100 depicting messaging between the client, the computing nodes, and the NAS, when a secondary copy of metadata is being transferred, or “cutover” to a new node. At 1110, discovery can occur via node status messages. At 1111, the node status messages can be sent around the ring from a starting point at a new node with pending secondary 1109, to the node with secondary 1008, to the node with primary 1006, to some node 1004. At 1112, the some node 1004, the node with primary 1006, and the node with secondary 1008 can update their slice route tables. The some node 1004 can additionally schedule scanning and priming operations. At 1113, the some node 1004 can continue to send node status back around the ring. At 1114, the new node with pending secondary 1109 can update its slice route table.

At 1120, there is a pending synchronization for the secondary copy. The pending secondary copy may need to be updated until the cut over is complete. At 1121, the prime results can be sent by the some node 1004 in a parallel fashion to the node with primary 1006, the node with secondary 1008, and the new node with pending secondary 1109. At 1122, the client 1002 can perform an operation that involves an update. The some node 1004 can communicate with the node with primary 1006 to access the metadata for the file at 1123. At 1124, the node with primary 1006 can respond to some node 1004, indicating that the file is not seeded and that the metadata is available. At 1125, the some node 1004 can communicate the response to the client 1002. At 1126, the some node 1004 can update the metadata on each of the node with primary 1006, the node with secondary 1008, and the new node with pending secondary 1109. At 1127, the some node 1004 can communicate prime results to each of the node with primary 1006, the node with secondary 1008, and the new node with pending secondary 1109. At 1128, each of the some node 1004, the node with primary 1006, the node with secondary 1108, and the new node with pending secondary 1109 can update their slice route tables. In the updated slice route table, the new node with pending secondary 1109 can replace the node with secondary 1008 as the secondary copy of the file metadata. The secondary copy can be purged from the node with secondary 1008.

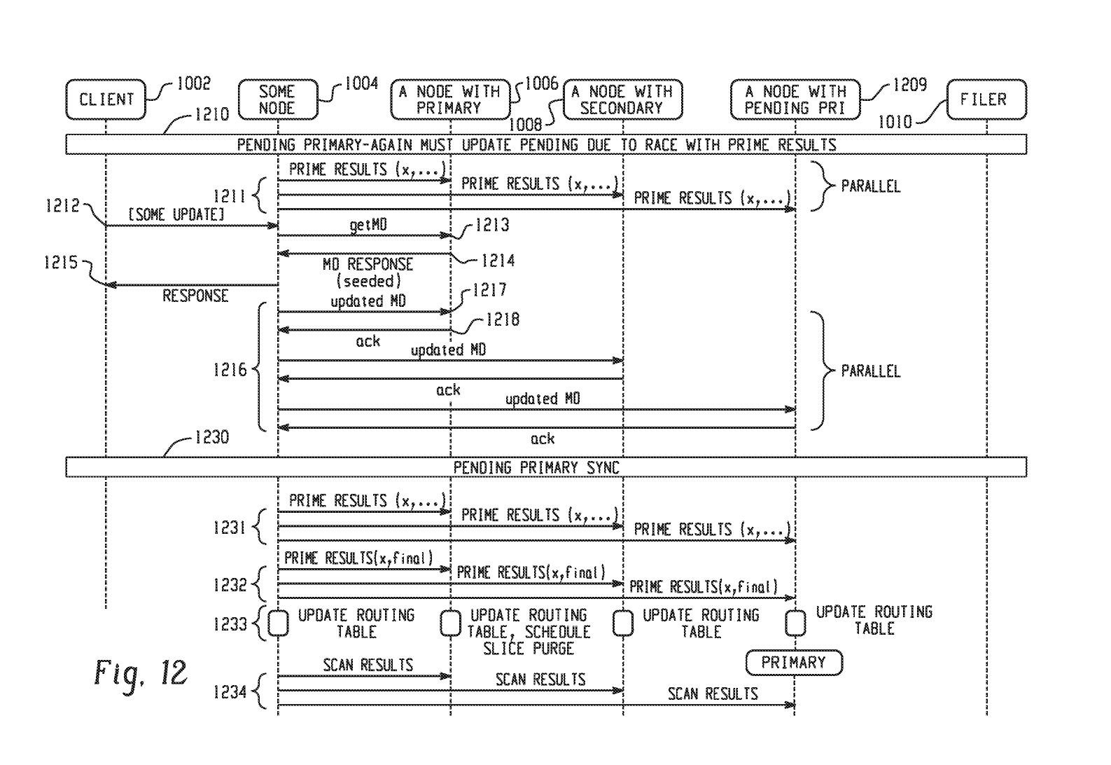

FIG. 12 is a diagram depicting messaging between the client, the computing nodes, and the NAS, when a primary copy of metadata is being transferred, or “cutover” to a new node. At 1210, there is a pending primary node. The pending primary node may need to have its metadata updated due to the race with the priming results. At 1211, the some node 1004 can send priming results to the node with primary 1006, the node with secondary 1008, and the node with pending primary 1209. At 1212, the client 1002 can perform an operation that involves an update. The some node 1004 can communicate with the node with primary 1006 to access the metadata for the file at 1213. At 1214, the node with primary 1006 can respond to some node 1004, indicating that the file is seeded and that the metadata is available. At 1215, the some node 1004 can communicates the response to the client 1002. At 1216, the some node 1004 can update the metadata on each of the node with primary 1006, the node with secondary 1008, and the new node with pending primary 1209. In each instance, the some node 1004 can receive an acknowledgement of the update from each of the node with primary 1006, the node with secondary 1008, and the new node with pending primary 1209.

At 1230, a pending primary synchronization occurs. At 1231, the some node 1004 can send prime results to the node with primary 1006, the node with secondary 1008, and the node with pending primary 1209. At 1231, the some node 1004 can send final prime results to the node with primary 1106, the node with secondary 1108, and the node with pending primary 1209. At 1233, the some node 1004, the node with primary 1006, the node with secondary 1008, and the node with pending primary 1209 can update their slice route tables. In the updated slice route table, the node with pending primary 1209 can replace the node with primary 1006 as the primary copy of the file metadata. The primary copy can be purged from the node with primary 1006. At 1234, the some node 1004 can send scan results to the node with primary 1006, the node with secondary 1008, and the node with pending primary 1209.

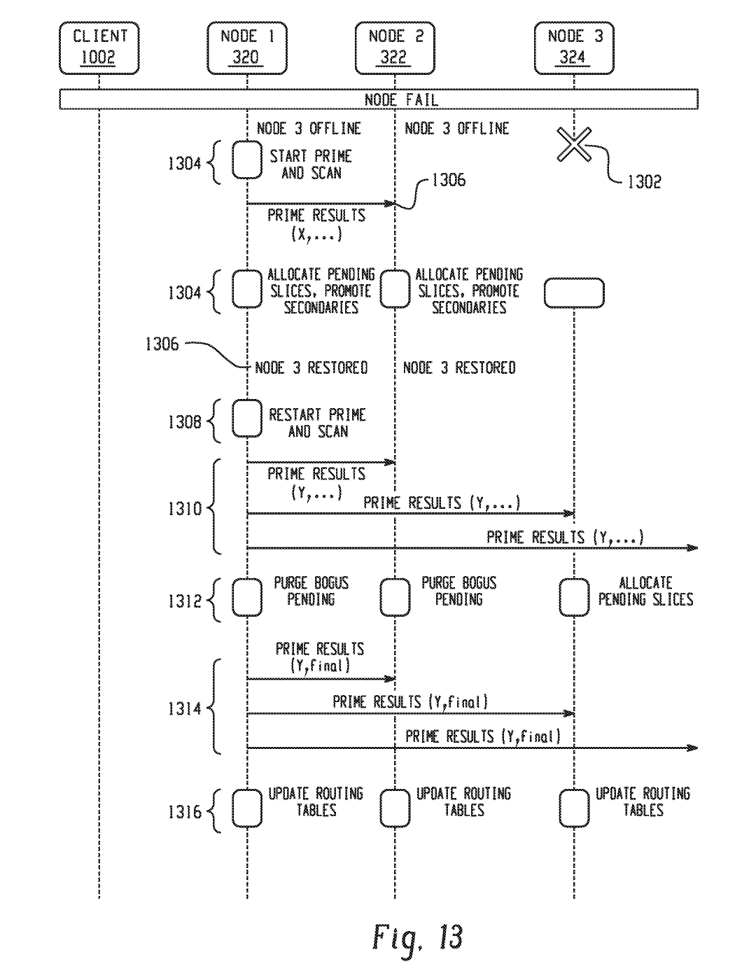

FIG. 13 is a diagram depicting messaging between the client and the computing nodes in an event of a node failure. At 1302, the third node 324 is offline. The first node 320 can start priming and scanning operations 1304. At 1306, the first node 320 can send the prime results to the second node 322. At 1304, the first node 320 and the second node 322 can allocate pending slices and promote secondary copies. The third node 324 is restored at 1306. At 1308, the first node 320 can restart the priming and scanning operations. The first node 320 can send the prime results to the second node 322 and the third node 324 at 1310. At 1312, the first node 320 and the second node 322 can purge the bogus pending primary or secondary copies. The pending slices can be allocated by the third node 324 at 1312. At 1314, the first node 320 can send the prime results to the second node 322 and the third node 324. The slice route tables can be updated by each of the first node 320, the second node 322, and the third node 324 at 1316.

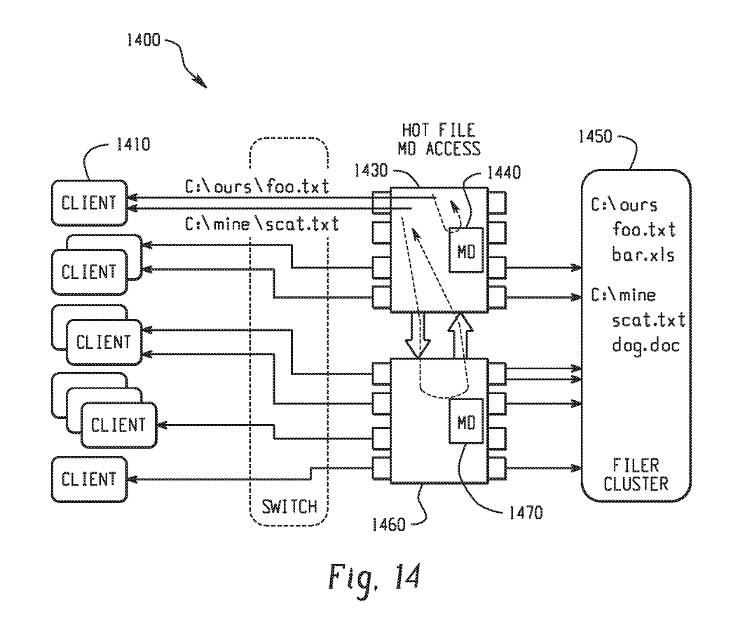

FIG. 14 is a diagram depicting “hot” file metadata access in a clustered node hybrid storage system 1400. In the clustered node hybrid storage system 1400, accesses can operate as if the cluster of nodes comprises a single node; however, multiple nodes may come into play on any given request, depending on where a file lives, e.g., on the NAS or on the cloud, and also depending on where the metadata for that file is stored.

File metadata can be distributed among then nodes in the cluster. Thus, the node that receives a request from the client can determine which node possesses the metadata, retrieve the metadata from (or updates the metadata to) the node, and respond to the client. In FIG. 14, a client 1410 can request information related to two files on an filer cluster 1450: C:\ours\foo.txt and CAmine\scat.txt. Metadata for the file C:\ours\foo.txt resides on an MDB slice 1440 in a node 1430, while metadata for the file CAmine\scat.txt resides on an MDB slice 1470 in a node 1460.

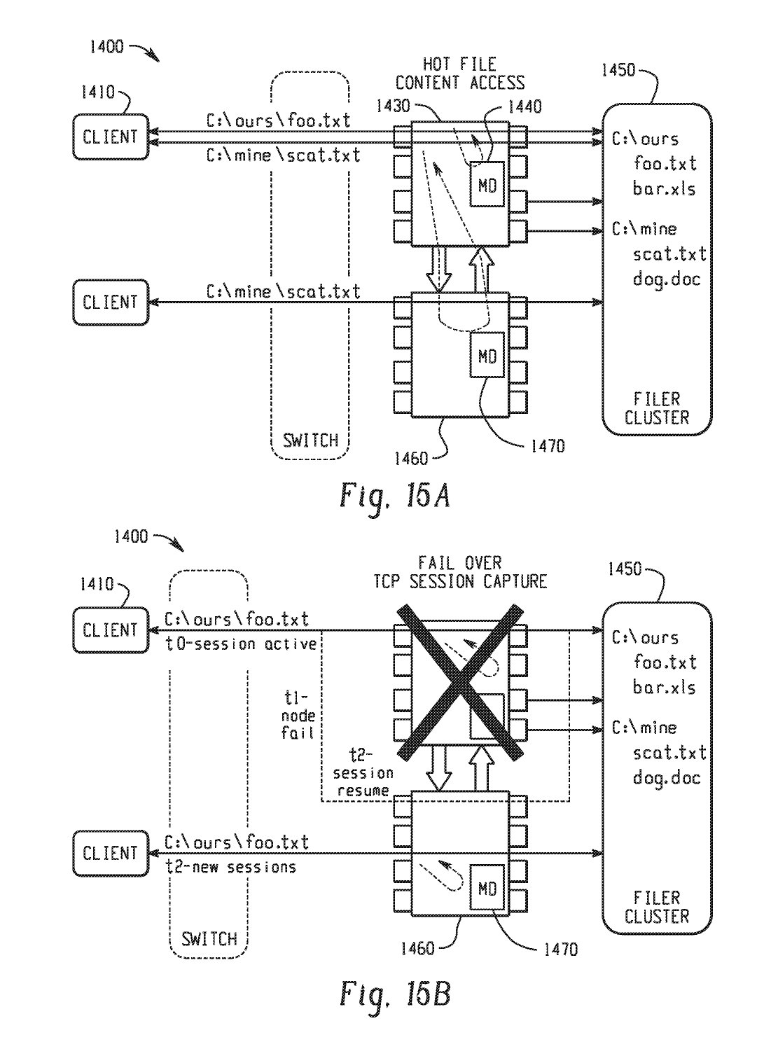

FIG. 15A is a diagram depicting “hot” file access in the clustered node hybrid storage system 1400. Metadata can be accessed from some node in the cluster to determine where the file resides, i.e., on the filer cluster 1450 or on the cloud, and the file is streamed from that location (the filer cluster 1450 in the case of a hot file). In this example, metadata for the file C:\ours\foo.txt can be accessed from the MDB slice 1440 in node 1430 to determine the file's location in the filer cluster 1450, and the file C:\ours\foo.txt is retrieved from the filer cluster 1450. Metadata for the file CAmine\scat.txt can be accessed from the MDB slice 1470 in node 1460 to determine the file's location in the filer cluster 1450, and the file CAmine\scat.txt can be retrieved from the filer cluster 1450.

FIG. 15B is a diagram depicting how a file can be accessed during a node failure. Upon node failure, another node can pick up TCP sessions from the failed node and resume them. In this example, at time t0, the first node is up and the session is active. File access occurs as normal. Upon failure of the first node at time t1, a second node picks up the TCP sessions and resumes them at t2. All new requests that would have been handled by the failed first node must now be handled by the second node. The connection can either be resumed from its previous state before the failure or the connection can be reset.

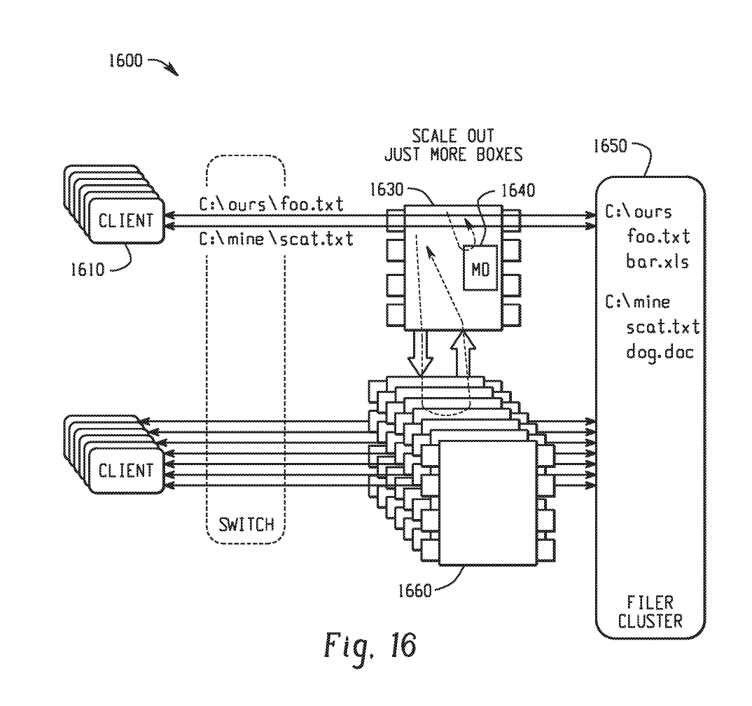

FIG. 16 is a diagram depicting a scale out of more nodes in the clustered node hybrid storage system 1600. The metadata for a particular file may reside on any node in the cluster, e.g., in MDB slice 1640 on a node 1630 or in an MDB slice in one or more additional nodes 1660. Each node may have up to four ports, or port pairs, connecting it to a switch or directly to the client 1610 and up to four ports connecting it to the NAS 1650. Thus, a node may have a total of up to eight data ports, or port pairs.

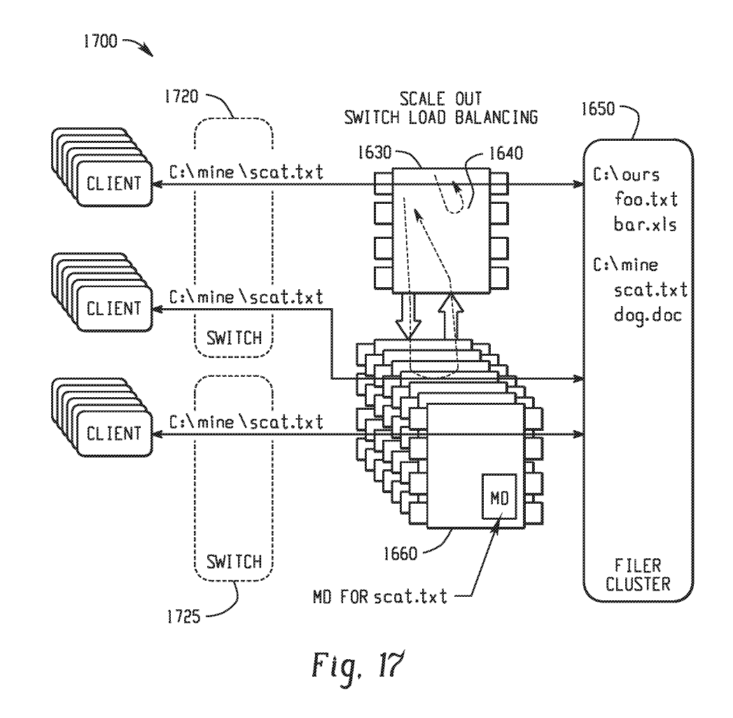

FIG. 17 is a diagram depicting the use of multiple switches 1720 and 1725 in a clustered node hybrid storage system 1700 to help balance the traffic in the network. The nodes may be connected to different clients, and different switches, yet the node 1630 in the system 1700 is still able to retrieve metadata from a different node 1660.

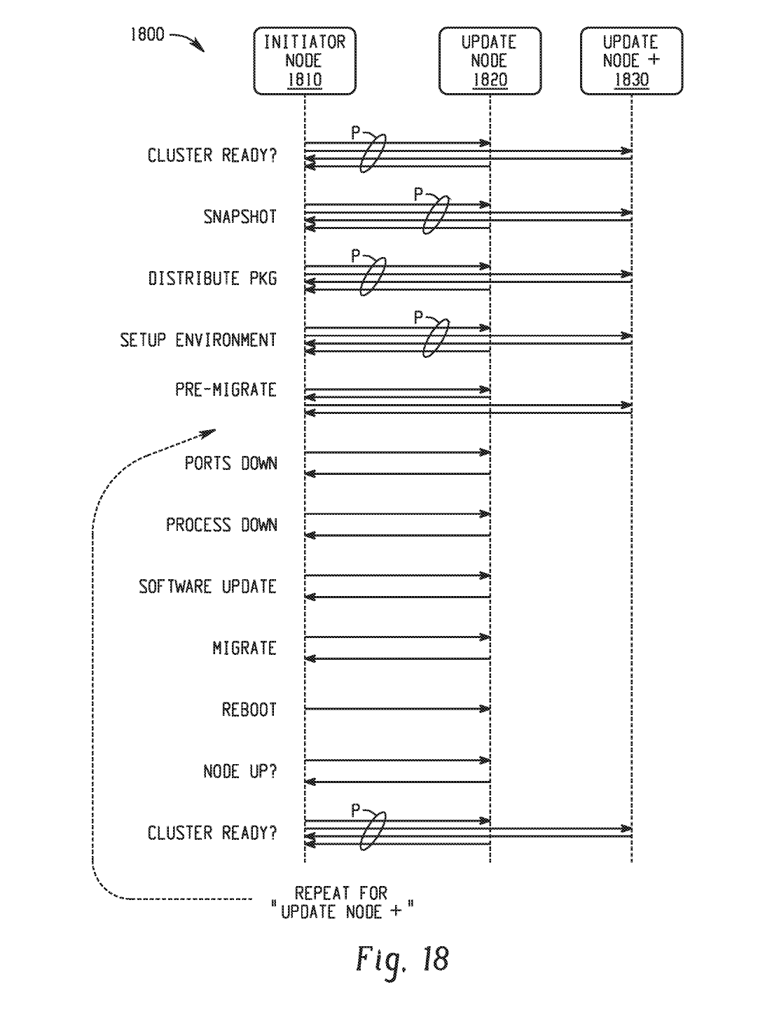

FIG. 18 depicts how an update to one or more computing nodes in a clustered hybrid storage system 1800 can be performed. The N+1 cluster architecture allows for one node to fail or otherwise be offline and the remaining nodes to continue to provide full services to the clients and applications using the clustered hybrid storage system. If the software on one or more computing nodes needs to be updated, it is highly desirable to perform that update in a manner such that clients and applications do not lose access to data in the hybrid storage system, i.e., perform a non-service impacting software update.

The non-service impacting software update can be performed by taking a single node at a time out of service, updating the software, migrating persistent data as necessary, rebooting the node and waiting for it to come up with all services back online. Once the node is updated and back online, the process can be repeated sequentially for the remaining nodes in the cluster. The final node to be updated is the one from which the cluster update was initiated, i.e., an initiator node.

In FIG. 18, an initiator node 1810, e.g., the node that is logged into by a user, can initiate the rolling cluster update. An update node 1820 is the currently updating (target) node. Update node+1830 represents the following nodes to update. “P” denotes parallel operations. The subsystems are each controlled by a cluster update process.

The non-service impacting cluster update may be described as a rolling update because the update “rolls through” each node in the cluster sequentially ending with the initiator node. The non-service impacting cluster update can coordinate and control across the cluster the following update subsystems:
package management: ability to download, validate, distribute, decrypt and extract software packages
snapshot: backup of current running system so that if there is an error during update the system can be rolled back and the node returned to pre-update state
setup environment: update needs to install it's on own code environment and not rely the current running system
pre-migrate: migrate data across cluster that requires all nodes to be up with processes and databases running
port control down/up: take data ports down to trigger the network high-availability equipment to route traffic through the active nodes in the cluster
process control down/up: take processes down/up to update their components
software update: update binaries, scripts, drivers, and operating system
migrate static code: post-software update, migrate data

Rolling update subsystem operations can be performed either serially to maintain control over the ordering of operations or in parallel for speed, as indicated by the circled arrows and corresponding “P” in FIG. 18.

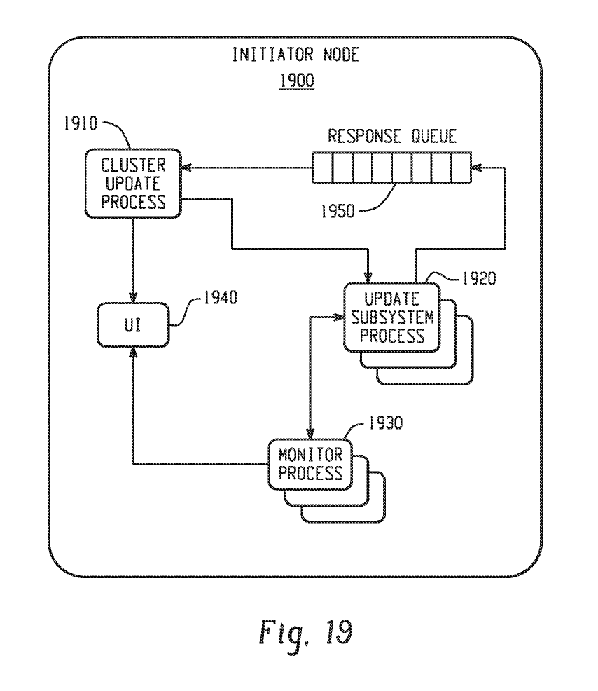

FIG. 19 depicts an initiator node 1900. Internally to the initiator node 1900, the cluster update control can spawn a process 1910 to handle each subsystem operation from FIG. 18. This allows for parallel or serial operations using a common framework. The update subsystem processes 1920 can communicate and control operations on a target node. Each update process 1920 can spawn a monitor process 1930 to query the updating (target) node. The monitor processes 1930 can notify a user of completed steps by displaying the steps as they are completed in a user interface 1940. A response queue 1950 comprises the responses from the update subsystem processes 1920 as they are completed. The cluster update control process 1910 can handle the responses and continue the cluster update or abort and begin a rollback.

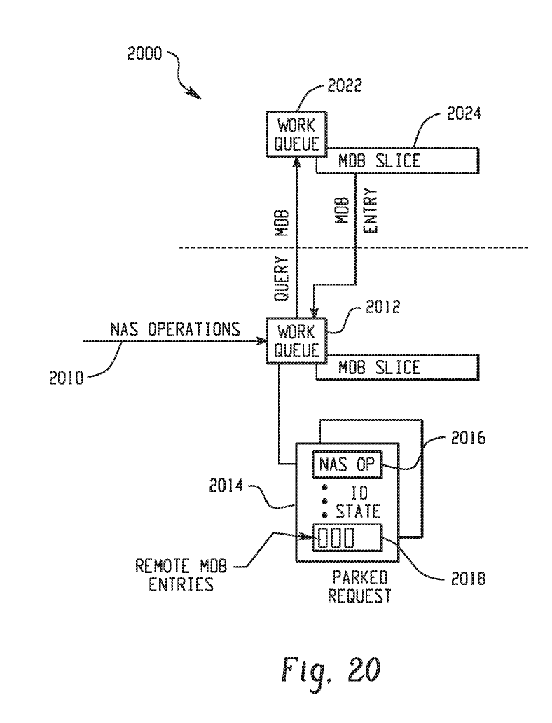

FIG. 20 is a diagram that depicts how a work queue for one slice accesses metadata in another slice in a clustered hybrid storage system 2000. NAS operations 2010 from the network can be distributed to the various work queues. In processing the NAS operations, it is often the case the metadata needed for the current NAS operation resides in an MDB slice on a different node, or in a different MDB slice on the same node. An operation might require MDB entries about more than one NAO, e.g., file. For example, a rename operation needs information about source and destination locations. When the request comes in, it is placed in the work queue 2012 of that node, regardless of whether the requested data is on that node. An engine process in that node pulls the metadata request from the work queue 2012 and looks at a slice route table to see if the metadata is local to that node. If the metadata is not local to that node, the engine process sends a query over the messaging infrastructure to a remote node based on the slice route table.

The messaging infrastructure between the nodes allows work queues to retrieve a copy of an MDB entry from a slice on other nodes, or from a different slice on the same node. When one or more remote MDB entries are required, an originating work queue 2012 can instantiate a structure 2014 to hold the current NAS operation 2016 and collected remote MDB entries 2018. The structure 2014 is called a parked request structure because the original operation is suspended, or parked, while waiting on all of the required MDB data. Each parked request 2014 can have a unique identifier that can be included in queries sent to other MDB slices, and can be used to associate the reply with the parked request. It can also contain a state variable to track the outstanding queries and what stage of processing the NAS operation 2016 is in. The originating work queue 2012 can send an MDB query 2120 to a work queue 2022, which can query an appropriate MDB slice 2024.

After the work queue 2012 creates the parked request and sends the MDB queries, processing for the NAS operation 2016 can be effectively suspended. The work queue 2012 can then start processing the next request in the queue. At any time there may be a large number of parked requests at various stages of processing associated with a work queue. Once the required MDB data arrives from other slices and the work queue has all it needs to continue, the parked request can be processed.

This method of suspending operations while collecting MDB information allows the system 2000 to maximize utilization of computing resources, while maintaining a run-to-completion model of processing the individual requests. As soon as a work queue has enough information to fully process the request, it does so. This ultimately results in less latency per operation and higher overall aggregate throughput. The result of processing a request could be to allow the request to pass through, to intercept the request and generate a response based on data from the MDB, or to trigger some other action in the cluster to migrate data to or from cloud storage.

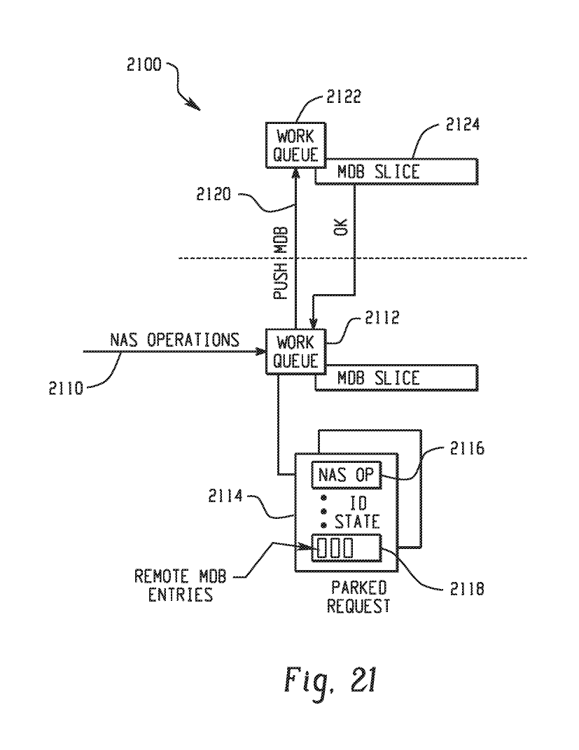

FIG. 21 depicts how new metadata is pushed to a slice on a same node or another slice in another node in a clustered hybrid storage system 2100. Some NAS operations 2110 can result in updated metadata that needs to be stored in the appropriate place in the MDB. Similar to the query messages to retrieve MDB data in FIG. 20, there can be an update messaging mechanism to push new metadata to the appropriate slice on the same node or another node. An originating work queue 2112 can instantiate a parked request structure 2114 to hold the current NAS operation 2116 and collect remote MDB entries 2118. A parked request structure 2114 can be used to track outstanding update requests. The originating work queue 2112 can send a push message 2020 to work queue 2122, which can push the update to the appropriate MDB slice 2124. Once all of the updates have been acknowledged, the operation is complete and the NAS operation 2116 can be forwarded or intercepted and the appropriate response generated.

To the extent possible, the MDB query operations or push operations can be dispatched in parallel to the various work queues. As the results and acknowledgements come back to the originating work queue, the parked request state tracks outstanding requests and determines the next steps to be performed. Some operations require a serialized set of steps. For instance, an NFS LOOKUP requires the work queue to first retrieve the parent directory attributes and child file handle. Once that is retrieved, the child file handle can be used to retrieve the child attributes. The parked request state variable can keep track of what information has been retrieved for this operation.

The work queue has a mechanism to reap parked requests that have existed for a time exceeding a timeout value. This can prevent resource leaks in cases where MDB query or push messages get lost by the messaging infrastructure, or if operations are impacted by loss of a cluster node. One embodiment of this mechanism can entail the work queue maintaining a linked list of parked requests that is sorted by the time the request was last referenced by the work queue. This is called a least recently used (LRU) list. When a message, such as a query result, is processed by the work queue, the associated parked request can be moved to the tail of the LRU. Each request contains a timestamp indicating when it was created. The work queue can periodically check items at the head of the LRU to see if any have exceeded the timeout.

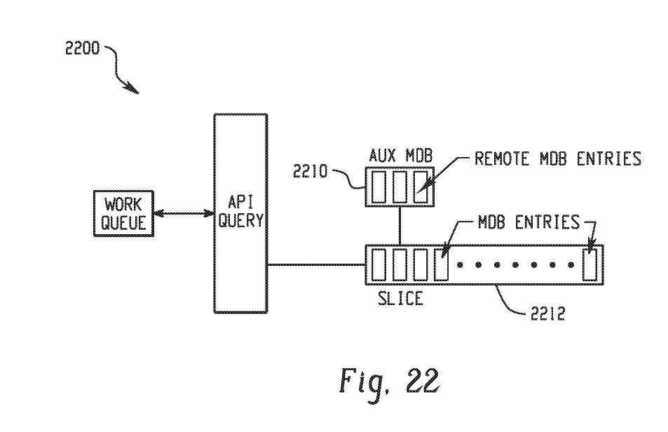

FIG. 22 is a diagram depicting an auxiliary MDB 2210 in a clustered hybrid storage system 2200. In order to simplify processing, the MDB entries collected from remote sources for a particular file system operation can be placed into a small version of the MDB, called the auxiliary MDB (auxMDB) 2210. There can be one auxMDB 2210 per in-process NAS operation, which holds only the remote MDB entries that have been collected for that operation. When processing the operation, the auxMDB 2210 can be appended to a local MDB 2212. This simplifies processing the operation because the metadata can be retrieved as if were all in the local MDB 2212. After the operation is processed, the auxMDB 2210 is detached from the local MDB 2212. Essentially use of an auxMDB can facilitate localized decisions based on data that is distributed across the cluster nodes, without requiring expensive locking.

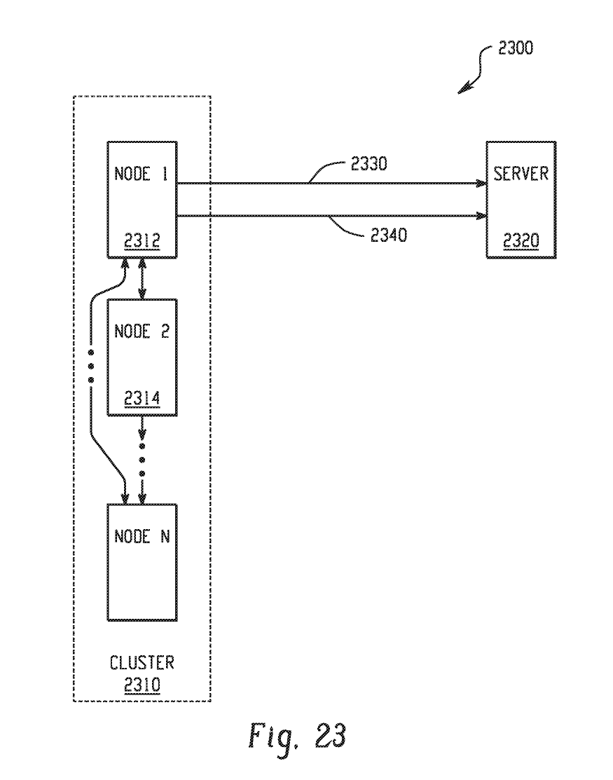

FIG. 23 is a diagram depicting a network topology 2300 with connections between computing nodes 1 through N in a cluster 2310 and a remote server 2320. The computing nodes 1 through N are connected to and communicate with each other through a backplane. These computing nodes may be referred to as tiering appliance nodes. Backplane routing can help to maintain connectivity to a remote server 2320 across the computing nodes. For example, a computing node in the cluster 2310 can connect to the remote server 2320 either by its own data port connection or through the data port connection of another node via the backplane of the cluster 2310. The computing node can connect to the remote server 2320 to perform a task, e.g., a unit of work done by one or more threads or one or more processes on the computing node requiring that requires connectivity to the remote server 2320.

The backplane can comprise network connections, network switches, InfiniB and interconnects, and remote direct memory access (RDMA)-based network adapters. The data port connections to the remote server 2320 can comprise a logical connection to the remote server 2320. For instance, the physical connection may be through a switch to the remote server 2320. The remote server 2320 may comprise a physical or virtual computer separate from the cluster 2310.

Network devices, e.g., servers or switches, typically have a limit on their data port density, i.e., the number of physical network connections. Network ports can be used to increase throughput or provide redundant network paths. The computing nodes in a cluster that communicates with a server will have data ports that are logically connected to the server. As a number of computing nodes in the cluster increases, the data port density increases, and it can become untenable for each computing node to establish a server connection through its own data ports. Thus, a computing node may instead rely on the data ports of other computing nodes for connectivity to the server.

The network topology 2300 can be shared across the cluster by processes that monitor connectivity and are agnostic to tasks. A task running on a computing node can send data to an IP address of the remote server 2320, and the data can be routed out a data port of the computing node or across the backplane as appropriate. Additionally, the task may query the API to determine if the server connection is local to its node or if it is a remote access. Through this mechanism, full connectivity to the server 2320 is provided for all nodes in the cluster 2310. Additionally, tasks can be delegated to any node in the cluster, even if the node performing the task does not have a server connection. The ability to delegate tasks can result in a reduction of computing loads for a given node.

The network topology 2300 could result in several scenarios. As one example, all server connections could be operational, and a task on Node 1 could utilize a first server connection 2330. As a second example, the first server connection 2330 could be non-functional, and a task on Node 2 could utilize a second server connection 2340 via Node 1. As a third example, the first and second server connections 2330 and 2340 could be operational, and a task on Node N could utilize the second server connection 2340 via Node 1.

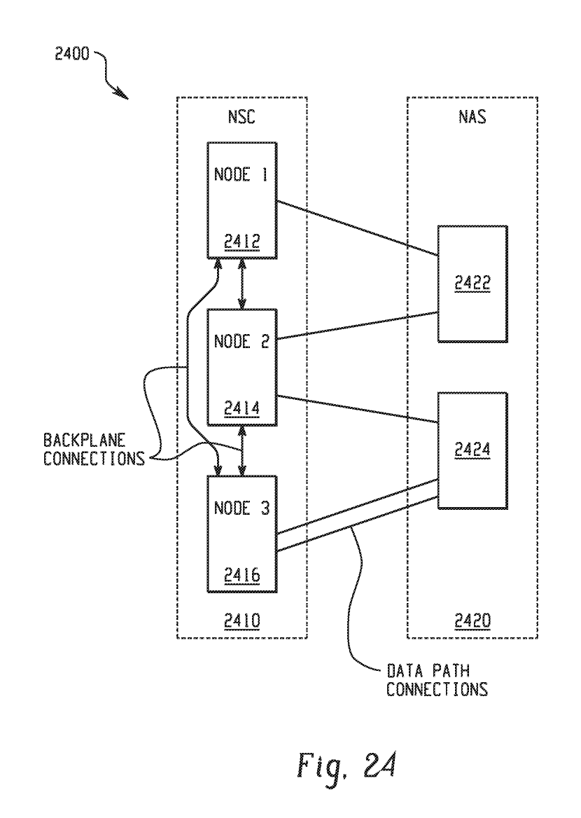

FIG. 24 depicts connections in a system 2400 for communicating between computing clusters. The system 2400 comprises an NSC, or a tiering appliance, 2410 and a NAS 2420. The NAS 2420, can comprise multiple controller nodes, or multiple, separate NAS file systems. Thus, the number of data port paths depends on a number of tiering appliance nodes in the cluster 2410 and a number of controller nodes of the NAS 2420, or alternatively, a number of NAS file systems. To ensure high availability of connectivity to the NAS 2420, typically there must be at least two tiering appliance nodes connected to each NAS controller node. There may be nodes that are not directly connected to each NAS node or each NAS file system. For these cases, it may be necessary for a computing node to access the NAS nodes indirectly via a backplane connection to another computing node.

The NSC 2410 comprises a first NSC node 2412, a second NSC node 2414, and a third NSC node 2416. The NAS 2420 comprises a first NAS node 2422 and a second NAS node 2424. The first NSC node 2412 is connected to the first NAS node 2422, the second NSC node 2414 is connected to both the first NAS node 2422 and the second NAS node 2424, and the third NSC node 2416 has two connections to the second NAS node 2424. Each of these network connections represents a different path. In an alternative configuration, there could be multiple, separate NAS file systems.

The first, second, and third NSC nodes 2412, 2414, and 2416, respectively, are interconnected by high-speed backplane links. In order to migrate files from the NAS 2420 to object-based storage, the NSC 2410 mounts file systems via the connections to the NAS 2420. Processes on the NAS nodes 2422 and 2424 operate on the mounts independently, so each NSC node 2412, 2414, and 2416 needs to be able to connect to the NAS nodes 2422 and 2424. To ensure high availability (HA), a minimum of two NSC nodes are connected to each NAS node 2422 and 2424. There may be NSC nodes that are not directly connected to each NAS node. For example, the first NSC node 2412 is not connected to the first NAS node 2422. For this case, it may be necessary for the first NSC node 2412 to access the first NAS node 2422 indirectly via a backplane connection to another NSC node.

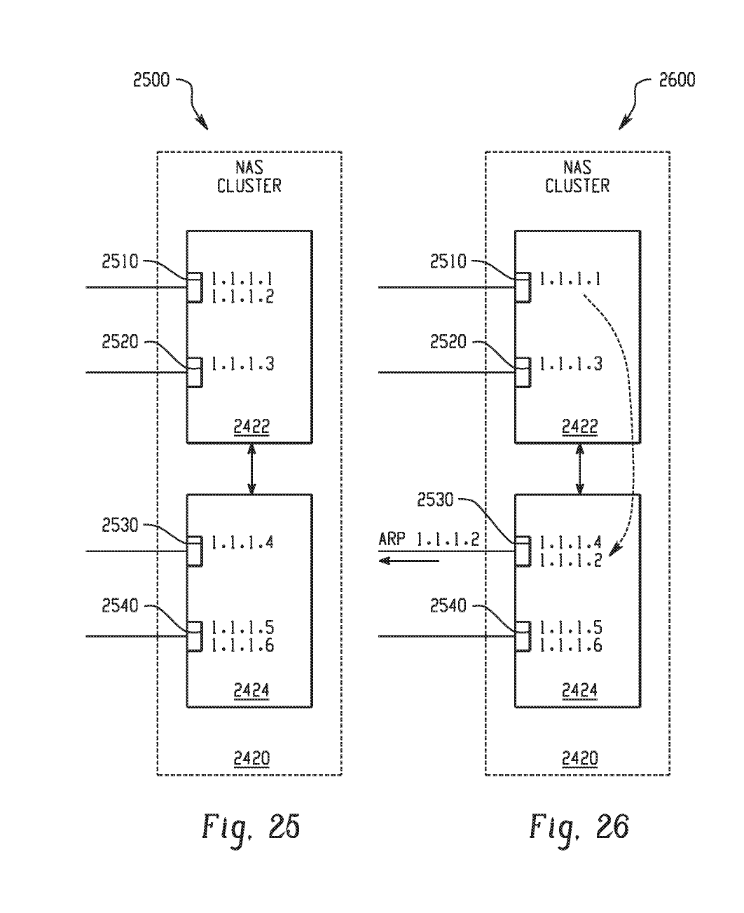

FIG. 25 depicts an IP addressing scheme for the NAS 2420. In the system 2500, the NAS 2420 comprises the first NAS node 2422 and the second NAS node 2424. The first NAS node 2422 comprises two physical network interfaces 2510 and 2520. The first physical network interface 2510 can be used to reach IP addresses 1.1.1.1 and 1.1.1.2. The second physical network interface 2520 can be used to reach IP address 1.1.1.3. The second NAS node 2424 comprises two physical network interfaces 2530 and 2540. The third physical network interface 2530 can be used to reach IP address 1.1.1.4. The fourth physical network interface 2540 can be used to reach IP addresses 1.1.1.5 and 1.1.1.6.

FIG. 26 depicts a movement of one of the IP addresses on the NAS 2420 and a subsequent gratuitous ARP being generated due to the movement. In the system 2600, the NAS 2420 has HA and load-balancing mechanisms that can move IP addresses from the first NAS node 2422 to the second NAS node 2424. For example, the NAS 2420, can move IP address 1.1.1.2 from the physical network interface 2510 on the first NAS node 2422 to the physical network interface 2530 on the second NAS node 2422. Alternatively, the NAS 2320 could move IP addresses between physical network interfaces on the same node. Because of the potential for movement of IP addresses, the NSC, e.g., NSC 2310, can dynamically track a mapping of IP addresses to physical network interfaces on the NAS 2420.

The NSC nodes 2412, 2414, and 2416 can take one or more steps, in any combination, to dynamically track NAS IP addresses. First, the NSC nodes 2412, 2414, and 2416 can perform an initial address resolution protocol (ARP) scan to determine which IP addresses are reachable for each NSC data path interface. Second, when the NAS 2420 moves IP addresses to a different network interface, it can generate a gratuitous ARP broadcast to trigger a switch in the NAS 2420 to update its forwarding table. The NSC 2410 can copy these ARP broadcasts to the control plane notify an IP address tracking process called nwatch. There can be a separate instance of IP address tracking process running on each NSC node 2412, 2414, and 2416. The IP tracking process can update the routing tables on the NSC nodes 2412, 2414, and 2416 so that packets destined for the NAS 2420 go to the correct network interface. Third, the IP tracking process can periodically perform an ARP scan to see which NAS IP addresses are reachable from each physical network interface. This ARP scan can be performed in the event that the NSC 2410 misses the gratuitous ARP from the NAS 2420 or if there is a network switch between the NSC 2410 and the NAS 2420. Any changes detected by this periodic ARP scan can result in routing table updates on the NSC nodes 2412, 2414, and 2416. Fourth, the instances of the IP tracking process can write data about visible IP addresses into a shared database so that each NSC node 2412, 2414, and 2416 is aware of the IP addresses reachable by other nodes. Given a current view of which IP addresses are reachable, the IP tracking process can select an available IP address for use in communicating with the NAS 2420.

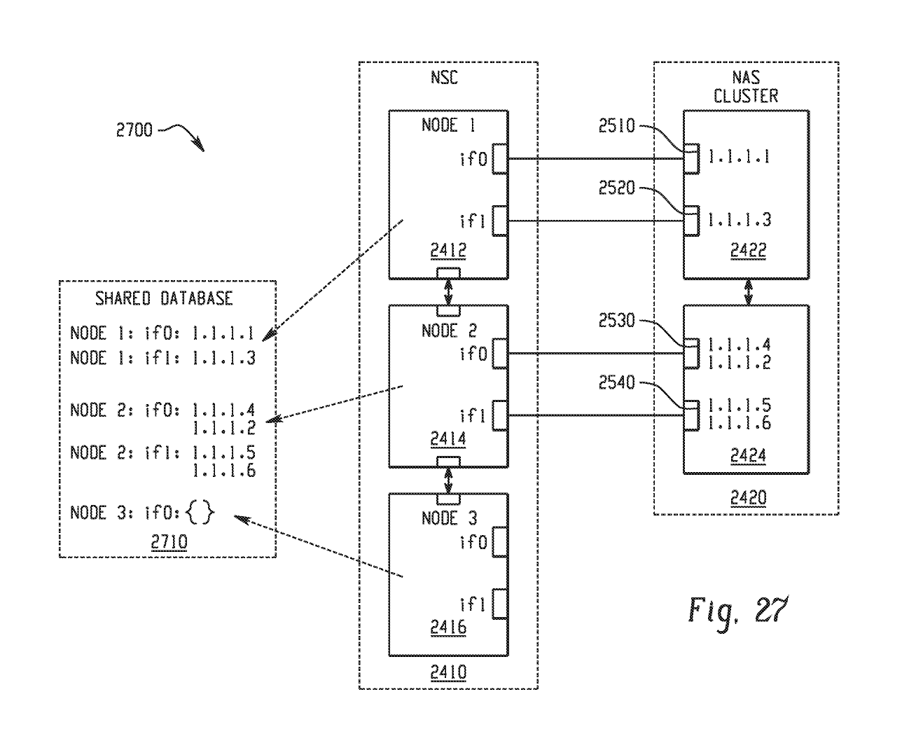

FIG. 27 depicts a shared database in a system 2700 for migrating files from a file server to object-based storage. When each of the NSC nodes 2412, 2414, and 2416 boots or there is a configuration change relating to the mapping NAS IP addresses to physical network interfaces, the IP tracking process can perform an initial ARP scan on physical network interfaces. The results from this initial ARP scan can be used to populate a shared database 2710. The shared database 2710 can comprise a mapping between the physical network interfaces on each NSC node 2412, 2414, and 2416 and the IP addresses on the NAS 2420 to which they connect. For example, physical network interface 0 on the first NSC node 2412 maps to IP address 1.1.1.1, and physical network interface 1 on the first NSC node 2412 maps to IP address 1.1.1.3. Physical network interface 0 on the second NSC node 2414 maps to IP addresses 1.1.1.2 and 1.1.1.4, and physical network interface 1 on the second NSC node 2414 maps to IP addresses 1.1.1.5 and 1.1.1.6. Physical network interface 0 on the third NSC node 2416 maps to no IP addresses.

The backplane can comprise a redundant stack of network switches. Processes running on the cluster can query an nwatch process through an API to find a best IP address to use to access the NAS 2420. Each IP address belonging to the NAS 2420 can be reachable through data ports of the NAS 2420. These processes include processes that scan the NAS 2420, migrate files from the NAS 2420 to an object-based storage, recall files from the object-based storage to the NAS 2420, etc. The nwatch process preferentially returns a NAS IP address that is reachable from a data port on the cluster node directly connected to the NAS 2420. In the event that no IP address on the NAS 2420 is directly reachable from the computing node that wants to reach the NAS 2420, the nwatch process can create a route to forward a request to another computing node in the cluster 2410 that has a direct connection to the NAS 2420. The packets for the request can be forwarded over the backplane switches to the directly-connected computing node, which then forwards the packets to the NAS 2420. The response packets can be returned along the same path in a reverse direction. If either a computing node or a NAS controller node becomes unavailable, nwatch can rediscover new paths and generate routes to maintain connectivity for the cluster 2410.

After initial discovery, the IP tracking process can select an IP address to use for communication from a computing node. IP addresses connected to local interfaces are always preferred, but if necessary, the IP tracking process can select an IP address associated with a data port on a remote node.

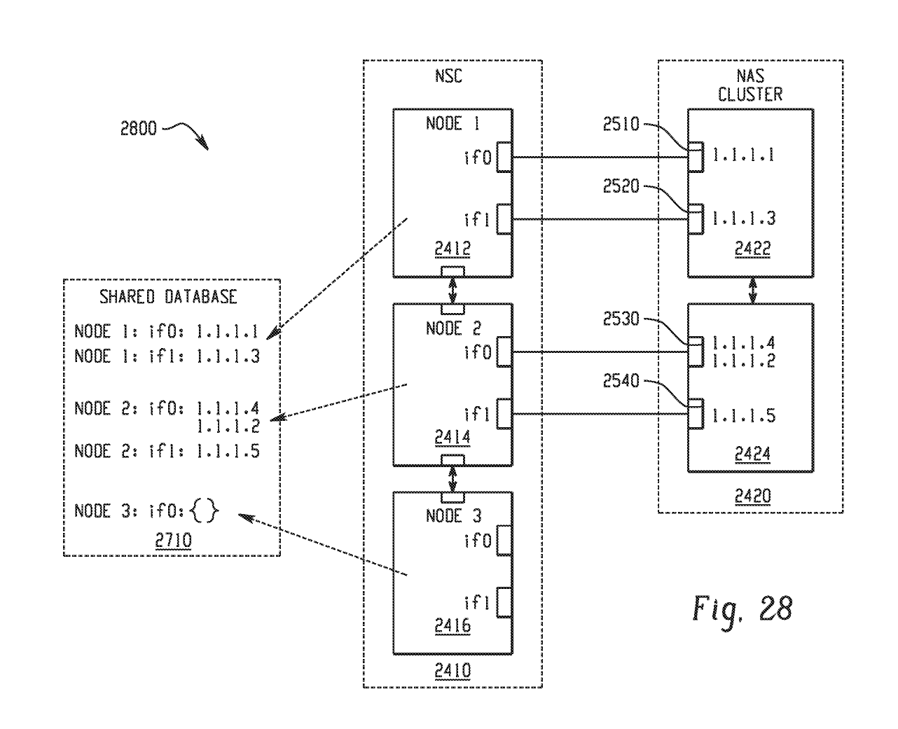

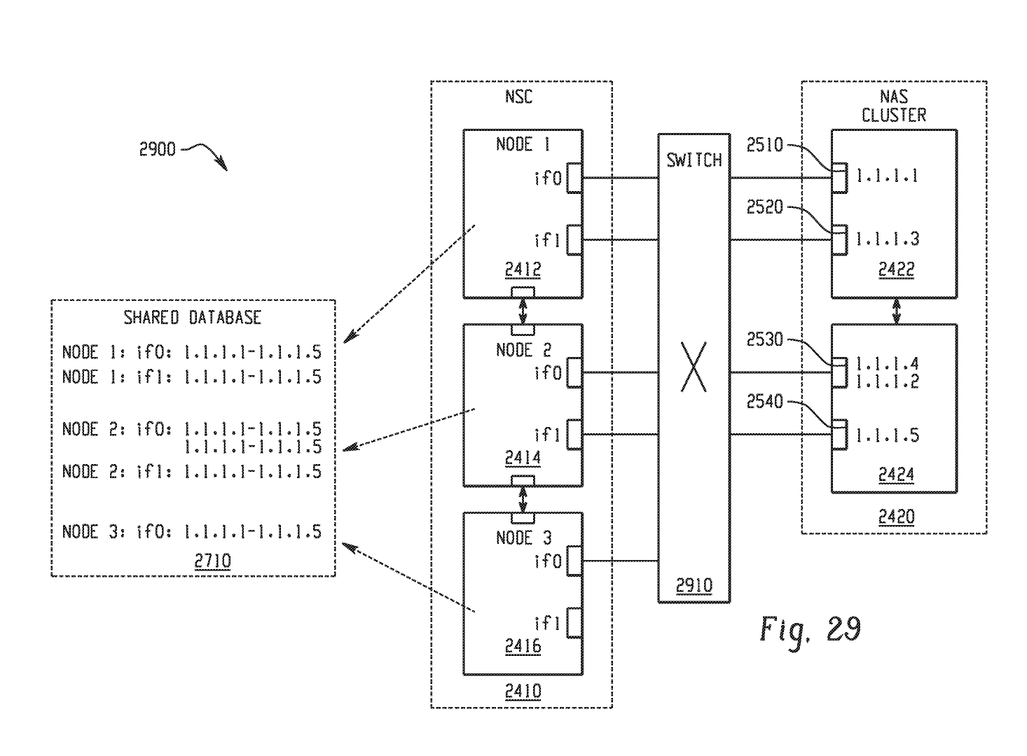

FIG. 28 depicts an updated shared database in a system 2800 for migrating files from a file server to object-based storage. Periodically, the IP tracking process can initiate an ARP scan for all of the configured IP addresses. This periodic scan can resolve cases where a gratuitous ARP was missed by the NSC 2410, or if there was a change in a configuration of the NAS 2420 that did not result in a gratuitous ARP, such as when an IP address is removed from a pool of IP addresses on the NAS 2420. For example, IP address 1.1.1.6 is removed from the pool of network addresses on the NAS 2420. The results of the periodic scan, i.e., that IP address 1.1.1.6 was removed, can be used to populate the shared database 2710. As a result, the shared database indicates that physical network interface 1 on the second node 2414 maps only to IP address 1.1.1.5 and not to IP address 1.1.1.6.

FIG. 29 depicts a shared database in a switched system 2900 for migrating files from a file server to object-based storage. There are cases where IP addresses can be reached on more than one physical network interface of the NSC 2410, i.e. if there is a switch between the NSC 2410 and the NAS 2420.

Because of the interconnectivity with the switch 2910, all NAS IP addresses are accessible from each physical network interface in the NSC 2410. For example, each of physical network interface 0 and physical network interface 1 on the first NSC node 2412 can access IP addresses 1.1.1.1, 1.1.1.2, 1.1.1.3, 1.1.1.4, and 1.1.1.5. Each of physical network interface 0 and physical network interface 1 on the second NSC node 2414 can access IP addresses 1.1.1.1, 1.1.1.2, 1.1.1.3, 1.1.1.4, and 1.1.1.5. Physical network interface 0 on the third NSC node 2416 can access IP addresses 1.1.1.1, 1.1.1.2, 1.1.1.3, 1.1.1.4, and 1.1.1.5.

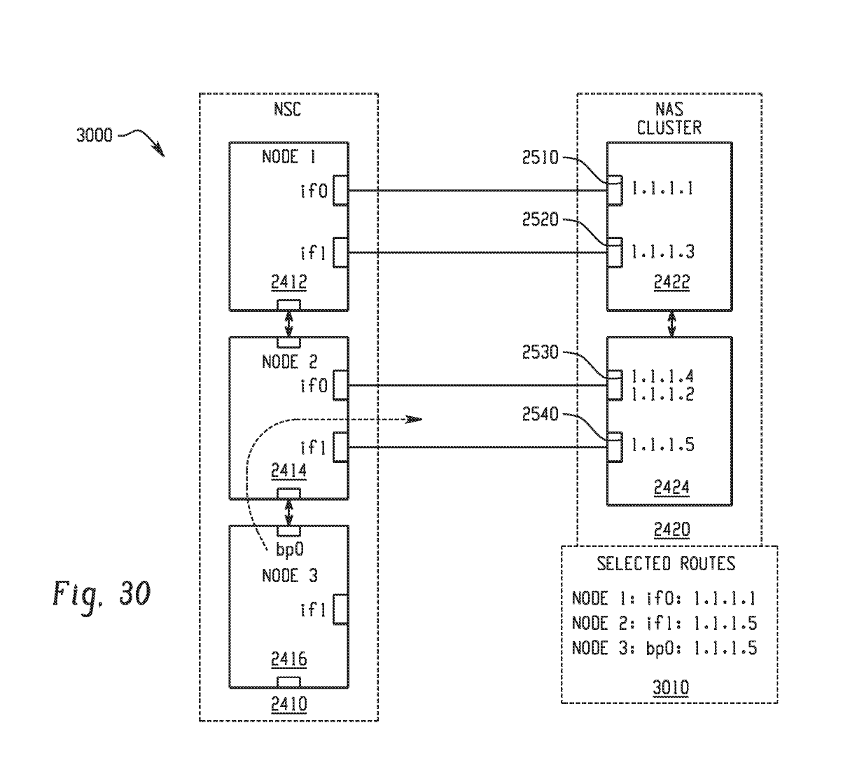

FIG. 30 depicts how an NSC node that is not connected to a NAS node can communicate with that NAS node. The IP tracking process can select IP addresses to use based on information in a shared database, e.g., shared database 2710. IP addresses associated with physical network interfaces that connect to the local node may be preferred. If no local connections are found, the IP tracking process can select an IP address connected to another node and set up routing over a backplane that connects each of the NSC nodes 2412, 2414, and 2416. Currently selected routes can be stored in a database 3010 so that other processes running on the NSC nodes 2412, 2414, and 2416 can find and use them. When the IP tracking process starts, it can select and try to use the route stored in the database. The database 3010 helps to keep the routes as stable as possible so that the other processes running on the NSC nodes 2412, 2414, and 2416 can rely on them. For example, the database 3010 can store a route for if0 on the first node 2412 to 1.1.1.1, a route for if1 on the second node 2414 to 1.1.1.5, and a route for bp0 on the third node 2416 to 1.1.1.5.

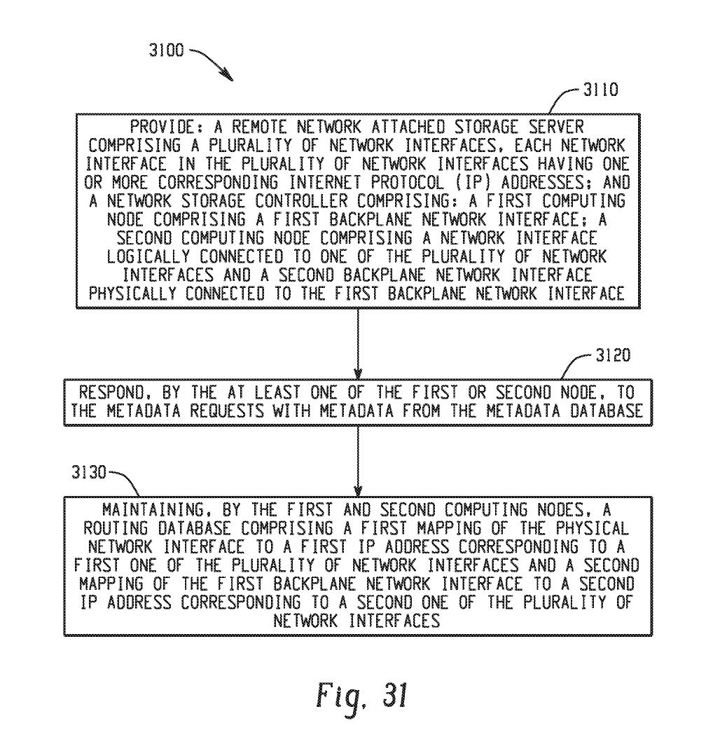

FIG. 31 is a flow diagram 3100 depicting a method for communicating between computing nodes reliably connected to a remote network attached storage server. At 3110, a remote network attached storage server comprising a plurality of network interfaces is provided. Each network interface in the plurality of network interfaces has one or more corresponding internet protocol (IP) addresses. A network storage controller comprising a first computing node comprising a first backplane network interface and a second computing node comprising a network interface logically connected to one of the plurality of network interfaces and a second backplane network interface physically connected to the first backplane network interface is provided. At least one of the first or second computing nodes are configured to perform deep packet inspection on network traffic between a client device and the remote network attached storage server. At 3120, the at least one of the first or second node responds to the metadata requests with metadata from the metadata database. At 3130, the first and second computing nodes maintain a routing database comprising a first mapping of the physical network interface to a first IP address corresponding to a first one of the plurality of network interfaces and a second mapping of the first backplane network interface to a second IP address corresponding to a second one of the plurality of network interfaces.

This written description describes exemplary embodiments of the invention, but other variations fall within scope of the disclosure. For example, the systems and methods may include and utilize data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

The methods and systems described herein may be implemented on many different types of processing devices by program code comprising program instructions that are executable by the device processing system. The software program instructions may include source code, object code, machine code, or any other stored data that is operable to cause a processing system to perform the methods and operations described herein. Any suitable computer languages may be used such as C, C++, Java, etc., as will be appreciated by those skilled in the art. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other non-transitory computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

1. A system for communicating between computing nodes reliably connected to a remote network attached storage server, the system comprising:
a remote network attached storage server comprising a plurality of network interfaces, each network interface in the plurality of network interfaces having one or more corresponding internet protocol (IP) addresses;
a network storage controller comprising:
a first computing node comprising a first backplane network interface;
a second computing node comprising a physical network interface logically connected to one of the plurality of network interfaces and a second backplane network interface physically connected to the first backplane network interface,
wherein at least one of the first or second computing nodes are configured to perform deep packet inspection on network traffic between a client device and the remote network attached storage server; and
a routing database shared by the first and second computing nodes, the routing database comprising a first mapping of the physical network interface to a first IP address corresponding to a first one of the plurality of network interfaces and a second mapping of the first backplane network interface to a second IP address corresponding to a second one of the plurality of network interfaces.

2. The system of claim 1, wherein the first computing node is configured to replace the second mapping if the second computing node becomes unavailable.

3. The system of claim 1, wherein the at least one of the first or second computing nodes performs an initial address resolution protocol (ARP) scan to determine if the IP addresses in the first and second mappings are reachable.

4. The system of claim 1, wherein the remote network attached storage server is configured to:
move an IP address from a first network interface in the plurality of network interfaces to a second network interface in the plurality of network interfaces; and
generate a gratuitous ARP broadcast to trigger the remote network attached storage server to update a forwarding table.

5. The system of claim 1, wherein the at least one of the first or second computing nodes are configured to:
periodically perform an ARP scan to determine if the IP addresses in the first and second mappings are reachable;
update the routing database based on a determination that at least one of the IP addresses in the first mapping or the second mapping is not reachable.

6. The system of claim 1, wherein the at least one of the first or second computing nodes are configured to:
update a database shared between the at least one of the first or second computing nodes and the remote network attached storage server with data about available IP addresses; and
select an available IP address for use in communicating with the remote network attached storage server based on the database.

7. The system of claim 6, wherein the least one of the first or second computing node selects the available IP address based on a priority given to physical network interfaces that connect directly to the remote network attached storage server over backplane network interfaces that connect indirectly to the remote network attached storage server.

8. A method for communicating between computing nodes reliably connected to a remote network attached storage server, the method comprising:
providing:
a remote network attached storage server comprising a plurality of network interfaces, each network interface in the plurality of network interfaces having one or more corresponding internet protocol (IP) addresses;
a network storage controller comprising:
a first computing node comprising a first backplane network interface;
a second computing node comprising a network interface logically connected to one of the plurality of network interfaces and a second backplane network interface physically connected to the first backplane network interface,
wherein at least one of the first or second computing nodes are configured to perform deep packet inspection on network traffic between a client device and the remote network attached storage server; and
responding, by the at least one of the first or second computing nodes, to the network traffic; and
maintaining, by the first and second computing nodes, a routing database comprising a first mapping of the physical network interface to a first IP address corresponding to a first one of the plurality of network interfaces and a second mapping of the first backplane network interface to a second IP address corresponding to a second one of the plurality of network interfaces.

9. The method of claim 8, further comprising:
replacing, by the first computing node, the second mapping if the second computing node becomes unavailable.

10. The method of claim 8, further comprising:
performing, by the at least one of the first or second computing nodes, an initial address resolution protocol (ARP) scan to determine if the IP addresses in the first and second mappings are reachable.

11. The method of claim 8, further comprising:
moving, by the remote network attached storage server, an IP address from a first network interface in the plurality of network interfaces to a second network interface in the plurality of network interfaces; and
generating, by the remote network attached storage server, a gratuitous ARP broadcast to trigger the remote network attached storage server to update a forwarding table.

12. The method of claim 8, further comprising:
periodically performing, by the at least one of the first or second computing nodes, an ARP scan to determine if the IP addresses in the first and second mappings are reachable;
sending, by the at least one of the first or second computing nodes, changes detected by the periodic ARP scan to the remote network attached storage server to update a routing table on the remote network attached storage server.

13. The method of claim 8, further comprising:
updating, by the at least one of the first or second computing nodes, a database shared between the at least one of the first or second computing nodes and the remote network attached storage server with data about available IP addresses; and
selecting, by the at least one of the first or second computing nodes, an available IP address for use in communicating with the remote network attached storage server based on the database.

14. The method of claim 8, further comprising:
selecting, by the at least one of the first or second computing nodes, the available IP address based on a priority given to physical network interfaces that connect directly to the remote network attached storage server over backplane network interfaces that connect indirectly to the remote network attached storage server.

15. A non-transitory computer-readable medium encoded with instructions for commanding one or more data processors to execute steps of a method for communicating between computing nodes reliably connected to a remote network attached storage server, the method comprising:
providing:
a remote network attached storage server comprising a plurality of network interfaces, each network interface in the plurality of network interfaces having one or more corresponding internet protocol (IP) addresses;
a network storage controller comprising:
a first computing node comprising a first backplane network interface;
a second computing node comprising a network interface logically connected to one of the plurality of network interfaces and a second backplane network interface physically connected to the first backplane network interface,
wherein at least one of the first or second computing nodes are configured to perform deep packet inspection on network traffic between a client device and the remote network attached storage server; and
responding, by the at least one of the first or second computing nodes, to the network traffic; and
maintaining, by the at least one of the first or second computing nodes, a routing database comprising a first mapping of the physical network interface to a first IP address corresponding to a first one of the plurality of network interfaces and a second mapping of the first backplane network interface to a second IP address corresponding to a second one of the plurality of network interfaces.

16. The non-transitory computer-readable medium of claim 15, the method further comprising:
replacing, by the first computing node, the second mapping if the second computing node becomes unavailable.

17. The non-transitory computer-readable medium of claim 15, the method further comprising:
performing, by the at least one of the first or second computing nodes, an initial address resolution protocol (ARP) scan to determine if the IP addresses in the first and second mappings are reachable.

18. The non-transitory computer-readable medium of claim 15, the method further comprising:
moving, by the remote network attached storage server, an IP address from a first network interface in the plurality of network interfaces to a second network interface in the plurality of network interfaces; and
generating, by the remote network attached storage server, a gratuitous ARP broadcast to trigger the remote network attached storage server to update a forwarding table.

19. The non-transitory computer-readable medium of claim 15, the method further comprising:
periodically performing, by the at least one of the first or second computing nodes, an ARP scan to determine if the IP addresses in the first and second mappings are reachable;
sending, by the at least one of the first or second computing nodes, changes detected by the periodic ARP scan to the remote network attached storage server to update a routing table on the remote network attached storage server.

20. The non-transitory computer-readable medium of claim 15, the method further comprising:
updating, by the at least one of the first or second computing nodes, a database shared between the at least one of the first or second computing nodes and the remote network attached storage server with data about available IP addresses; and
selecting, by the at least one of the first or second computing nodes, an available IP address for use in communicating with the remote network attached storage server based on the database.
